(19) United States
(12) Patent Application Publication
(10) Pub. No.: US 2017/0028674 A1
(43) Pub. Date: Feb. 2, 2017

(54) GRAPHENE OR CARBON NANOTUBE MATERIALS AND METHOD OF MAKING AND USING THE SAME

(71) Applicant: University of Virginia Patent Foundation, Charlottesville, VA (US)

(72) Inventors: Haydn N.G. Wadley, Keswick, VA (US); Vikram Deshpande, Cambridge (GB); Felice Torrisi, Cambridge (GB)

(21) Appl. No.: 15/303,946

(22) PCT Filed: Apr. 14, 2015
(86) PCT No.: PCT/US15/25774

§ 371 Date: Oct. 13, 2016

Related U.S. Application Data
(60) Provisional application No. 62/053,527, filed on Sep. 22, 2014.
(60) Provisional application No. 61/979,310, filed on Apr. 14, 2014.

(51) Int. Cl. B32B 5/16; B32B 27/06; C01B 31/04; B32B 37/14

(52) U.S. Cl. CPC B32B 5/16; B32B 37/14; B32B 27/06; C01B 31/0446; B32B 2307/54; B32B 2305/30

(57) ABSTRACT

A graphene composite, and method of making and using the graphene composite.

### RELATED PATENT APPLICATIONS

This application claims priority from U.S. Provisional Application No. 61/979,310 filed Apr. 14, 2014, under 35 U.S.C. §119 (e) and PCT Article 8.

### FIELD

A graphene composite comprising or consisting of alternating layers of graphene (or other 2D van der Waals bonded solid with ultrahigh in-plane tensile strength) and thin layers of a polymer (e.g. polyethylene). Weak bonds between the two materials are exploited during tensile loading to promote pull-out of the plates and stresses that approach the in-plane tensile strength of the graphene. When properly assembled this state of matter has a higher ballistic limit than other currently conceived polymer based armor.

### BACKGROUND

Graphene composites made-to-date are rather simple systems comprising very low graphene volume fractions (typically less than 1% with poor flake alignment. These problems are primarily related to: (i) the inability to produce graphene in high volume at low cost, and (ii) the use of composite manufacturing routes that attempt to go from the atomic scale graphene to large scale composites in a single step.

There exists a need to have atomic/nano-scale alignment of grapheme, but also achieving high loadings. The composites must also be manufactured with thicknesses measured in millimetres and areas on the scale of meters for ballistic applications. Moreover, control of the nano-scale features (graphene flake size, crystalline perfection, alignment etc.) are critical to achieve the macro-scale properties.

### SUMMARY

An improved composite material, and method of making and using.

An improved graphene composite material, and method of making and using.

A method of making a graphene composite comprising or consisting of making graphene flakes or tiles: making a graphene layer from the graphene flakes or tiles; and applying a polymer layer to the graphene layer.

A method of making a graphene composite comprising or consisting of layering graphene layers and polymer layers such as polyethylene layers.

A method of making a graphene composite comprising or consisting of connecting and alternating layers of graphene layers and polymer layers such as polyethylene layers.

A method of making a graphene composite using graphene flakes or tiles.

A method of making a graphene composite using hexagon shaped graphene flakes or tiles.

A method of making a graphene composite using multiple graphene layers and polymers layers such as polyethylene layers.

A method of making a graphene composite comprising or consisting of alternating graphene layers and polyethylene layers.

A method of making a graphene composite comprising or consisting of consecutive graphene layers arranged so that the graphene flakes or tiles of one graphene layer overlap joints of graphene flakes or tiles of a next consecutive layer.

A method of making a graphene composite comprising or consisting of graphene flakes or tiles of one graphene layer centered over the joints of graphene flakes or tiles of a next consecutive layer.

A method of making a graphene composite comprising or consisting of graphene flakes or tiles have a width of 20 μm and a thickness of 0.335 nm.

A method of making a graphene composite comprising or consisting of graphene flakes or tiles made by passing a input graphite slurry under pressure through a micro-fluidic labyrinth; separating the graphene flakes or tiles; making a graphene ink; printing or spraying one or more graphene layers; making nano-scale thick composite plies; and roll bonding the nano-scale thick composite plies to produce a micro-scale composite.

A graphene composite comprising or consisting of a graphene layer comprising graphene flakes or tiles; and a polymer layer such as polyethylene connected to the graphene layer.

A graphene composite comprising or consisting of one or more graphene layers comprising or consisting of graphene flakes or tiles have a width of 20 μm and a thickness of 0.335 nm.

A graphene composite comprising or consisting of alternating layers of the graphene layer and the polymer layer.

A graphene composite comprising or consisting of graphene layers with the graphene flakes or tiles of one graphene layer overlapping with the joints between graphene flakes or tiles of the next consecutive graphene layer.

A graphene composite comprising or consisting of graphene layers with graphene flakes or tiles of the one graphene layer centered over the joints of the graphene flakes or tiles of the next consecutive graphene layer.

Practice of an aspect of an embodiment (or embodiments) of the invention will be still more fully understood from the following examples and results, which are presented herein for illustration only and should not be construed as limiting the invention in any way.

The various embodiments of the structures, compositions, systems, devices, and materials discussed in this disclosure may be utilized and implemented for a number of products and services. For instance, it should be appreciated the following provides a non-limiting list of examples that represent embodiments that are considered part of the present invention and may, of course, be employed within the context of the invention.
1. Heat Pipe System, structures, or devices,
2. Heat Sink system, structures, or devices,
3. Thermal Management Systems (TMS),
4. Ballistic resistant and mitigation devices, structures, and systems,
5. Projectile resistant and mitigation devices, structures, and systems,
6. Missile resistant and mitigation devices, structures, and systems,
7. Blast resistant and mitigation devices, structures, and systems,
8. Heat resistant devices, structures, and systems,
9. Electrical insulating devices, structures, and systems,
10. Armor plating system, device, or structure,
11. Tank plating system, device, or structure,
12. Armor system, device, or structure,
13. Lattice structure (for example, but not limited thereto, tetrahedral, pyramidal, three-dimension kagome, kagome, or any combination thereof),
14. Cellular structure,
15. Corrugation structure (for example, but not limited thereto, triangular, diamond, multi-layered, flat-top, Navtruss, or any combination thereof),
16. Honeycomb structure (for example, but not limited thereto, hexagonal cell, square cell, cylindrical, rectangular cell, triangular cell or any combination thereof),
17. Panel structure,
18. Face layer,
19. Sandwich structure,
20. Modular layer structure or multilayer component,
21. Multifunctional structure or component,
22. Smart memory alloy (SMA) system, device, or structure,
23. Textile weave structure, woven structure, mesh structure, braid structure, multilayer textile structure, or any combination thereof,
24. Architectural structure (for example: pillars, walls, shielding, foundations or floors for tall buildings or pillars, wall shielding floors, for regular buildings and houses),
25. Civil engineering field structure (for example: road facilities such as noise resistant walls and crash barriers, road paving materials, permanent and portable aircraft landing runways, permanent or portable landing pads, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, airport structures such as runways), military security/protection/defense structures;
26. Machine structure (for example: frame structures for carrying system, carrying pallets, frame structure for robots, etc.),
27. Automobile structure (for example: body, frame, doors, chassis, roof and floor, side beams, bumpers, etc.),
28. Ship structure (for example: main frame of the ship, body, deck, partition wall, wall, etc.),
29. Freight car structure (for example: body, frame, floor, wall, etc.),
30. Aircraft structure (for example: wing, main frame, body, floor, etc.),
31. Spacecraft structure (for example: body, frame, floor, wall, etc.),
32. Space station structure (for example: the main body, floor, wall, etc.), and
33. Submarine, ship or water craft structure (for example: body, frame, etc.).
34. Military vehicle (tank, automobile, robot, etc.),
35. Parts for marine vessel hulls or decks or parts for hovercraft, and other amphibious vehicles,
36. Frames to any air, space, or water craft, vehicle or robot,
37. Outer skin or inner skin, as well as other components, of any air, space, or water craft, vehicle or robot,
38. Any building structures or components of building structures,
39. Any automotive component, bodies, frames, chassis and components,
40. Transportation land, air, or sea vehicle, craft or robot,
41. Electronics systems or components of such electronic systems, as well as other components and housings,
42. Multifunctional system, device, or structure,
43. Struts or the like,
44. Jet Blast Deflector (JBD) system,
45. Armor suit (or portions thereof) for military personnel or other human or animal subjects,
46. Armor shield for military personnel or other human or animal subjects,
47. Armor helmet or mask (or portions thereof) for military personnel or other human or animal subjects,
48. Armor gear (or portions thereof) and accessories for military personnel or other human or animal subjects,
49. Armor suit for military robot or other types of robots,
50. Rods, bars or other elongated members,
51. I-beam, H-beam, or other beam like structures,
52. Impact resistant and mitigation devices, structures, and systems,
53. Force resistant and mitigation devices, structures, and systems,
54. Shock absorption devices, structures, and systems,
55. Crash deflection and mitigation devices, structures, and systems,

This disclosure also covers:
1) graphene/nano-scale manufacturing;
2) micron-mm scale manufacture;
3) molecular modeling;
4) micro-mechanical/ballistic performance modeling;
5) Al nano-scale manufacture;
6) graphene applications, utilizing;
7) use of state-of-art clean room facilities with a polymer composite manufacturing suite and nanomaterials processing printing, coating and deposition systems;
8) TA2 assembly of millimetre scale structures; and
9) novel materials and processing approaches for making giant and tunnelling magnetoresistive multilayers with monoatomic thickness control, thermal and environmental barrier coatings, microarchitectured cellular materials and a variety of ballistic impact resistant structures that include polyethylene based fibers and tapes.

### BRIEF DESCRIPTION OF DRAWINGS

FIG. 1 is a screen shot showing a graphene composite.

FIG. 2 is a screen shot showing overlapping of the graphene flakes or tiles between consecutive grapheme layers.

FIG. 3 is a screen shot showing a graph of Cunniff velocity verses Volume fraction of graphene.

FIG. 4 is a screen shot showing a graph of Specific energy absorption verses Extensional wave speed of various engineering materials.

FIG. 5 is a screen shot showing a diagram of design, manufacture, and measurement/properties of graphene composites.

FIG. 6 is a screen shot showing a diagram of graphene flake production.

FIG. 7 is a screen shot showing a table of various techniques for making graphene flakes.

FIG. 8 is a screen shot showing a table of various techniques for making graphene layers.

FIG. 9 is a screen shot showing a graph of Tensile strength verses Young's modulus for various engineering materials.

FIG. 10 is a screen shot showing a graph of Cunniff velocity verses Volume fraction of graphene for graphene composites.

FIG. 11 is a screen shot showing a graph of Fracture toughness verses Strength of various engineering materials.

FIG. 12 is a screen shot showing a graph of Compressive strength verses Density and Fracture toughness verses Density of various engineering materials.

FIG. 13 is a screen shot showing a graph of Fracture toughness verses Strength of various engineering materials.

FIG. 14 is a screen shot showing various types of cellular structures.

FIG. 15 is a screen shot showing a table of Young's modulus verses Density of various engineering materials and a composite sample.

FIG. 16 is a screen shot showing the making of an octet truss from a fibre reinforce composite.

FIG. 17 is a screen shot showing a graph of Compressive strength verses Density of various engineering materials.

FIG. 18 is a screen shot showing a graph of Average Engineering Stress@1% strain verses Specimen Diameter.

FIG. 19 is a screen shot showing images of In-situ TEM imaging during compression.

FIG. 20 is a screen shot showing various composite morphologies.

FIG. 21 is a screen shot showing the manufacture of a metal gyroid.

FIG. 22 is a screen shot showing images of Ni gyroids with nano-scale struts.

FIG. 23 is a screen shot showing the test, graph of Hardness verses Indentation, and image of the material for indentation experiments to probe strength.

FIG. 24 is a screen shot showing the double gyroid structure, graph of True Stress verses True Strain of the gyroid, and graph of Hardness verses 0.2 a/R.

FIG. 25 is a screen shot showing other options for nano-scale lattice manufacture.

FIG. 26 is a screen shot showing images of a whole range of topologies manufactured by this process.

FIG. 27 is a screen shot showing a map of Compressive strength verses Density of lattices achieved to-date.

FIG. 28 is a screen shot showing a map of Compressive strength verses Density of carbon based systems.

FIG. 29 is a screen shot showing a test and graph for toughness.

FIG. 30 is a screen shot showing lattice tend to be intrinsically tough.

FIG. 31 is a screen shot showing a graph of Force verses Crack-mouth opening displacement and sample image.

FIG. 32 is a screen shot showing a Summary of K_{IC} measurements.

FIG. 33 is a screen shot showing a Scaling of strength & toughness with cell size.

FIG. 34 is a screen shot showing how toughness scales with cell size.

FIG. 35 is a screen shot showing the use of numerical models to determine topology toughness relations.

FIG. 36 is a screen shot showing predictions of the fracture toughness of elastic/brittle lattices.

FIG. 37 is a screen shot showing the structure of gyroid and octet truss micro-architectured materials.

FIG. 38 is a screen shot showing a map of Fracture toughness verses Strength of various engineering materials.

FIG. 39 is a screen shot showing the structure of Octet Lattice from Gyroid Nanolattice and an Octet Lattice from Octet Nanolattice.

FIG. 40 is a screen shot showing a map of Fracture toughness verses Strength of various engineering materials.

FIG. 41 is a screen shot showing possibilities of nano-scale inclusions.

FIG. 42 is a screen shot showing what CNTs are doing.

FIG. 43 is a screen shot showing Specific strength verses Specific modulus for various engineering materials.

FIG. 44 is a screen shot showing characteristics of grapheme composites.

FIG. 45 is a screen shot showing how far are these composites off the theoretical maximum.

FIG. 46 is a screen shot showing what can be achieved with perfect grapheme composites.

FIG. 47 is a screen show showing possible applications of such composites.

FIG. 48 is a screen shot showing a map of a Specific energy absorption verses Extensional wave speed of various engineering materials.

FIG. 49 is a screen shot showing the potential of graphene composites as ballistic material.

FIG. 50 is a screen shot showing a Summary of Lattices and Composites of Graphene.

FIG. 51 is a screen shot showing the structure of a graphene layer and alternating graphene/polyethylene layers.

FIG. 52 is a screen shot showing the structure of a graphene composite.

FIG. 53 is a screen shot showing the structure of a graphene-polyethylene composites.

FIG. 54 is a screen shot showing graphene armor plates.

FIG. 55 is a screen shot showing a map of mechanical properties and material indices for candidate ballistic materials.

FIG. 56 is a screen shot showing mechanisms of ballistic failures.

FIG. 57 is a screen shot showing a 1D fiber approach to armor.

FIG. 58 is a screen shot showing a failure strength of Carbon Nano Tubes (CNT).

FIG. 59 is a screen shot showing characteristics of a CNT Doped Aluminum.

FIG. 60 is a screen shot showing 2D nanoscopic materials.

FIG. 61 is a screen shot showing graphene having very high strength and modest defect sensitivity.

FIG. 62 is a screen shot showing graphene-polymer composites.

FIG. 63 is a screen shot showing the structure of a 50% graphene-polyethylene composites.

FIG. 64 is a screen shot showing materials having exceptional ballistic properties.

FIG. 65 is a screen shot showing an example of a 50% graphene-polyethylene composite using rectangular shaped graphene (ribbons).

FIG. 66 is a screen shot showing an example of a 50% graphene-polyethylene composite using hexagonal graphene sheets.

FIG. 67 is a screen shot showing what can be achieved with perfect graphene composites.

### DETAILED DESCRIPTION

Graphene is a remarkable macromolecule. With a density of only 1500 to 2000 kgm⁻³, perfect graphene sheets have an in plane tensile strength of over 100 GPa, and an elastic modulus of 1 TPa, but forms very weak van der Waals bonds with other materials in the out of plane direction.

The assembly will use an atoms to product (A2P) approach to assemble millimeter thick laminates from graphene-polyethylene multilayers with mono atomic layer spacing. This material will possess a five-fold higher ballistic resistance than the current state of the art material (Grade HB 212 Dyneema—a material made from aligned 10 □m long, polyethylene molecules with a strength of 7 GPa and modulus of about 200 GPa), and suffer substantially smaller, behind armor dynamic deflections. It therefore offers transformational opportunities for soldier and vehicle protection.

An aspect of the A2P approach is based upon, among other things, affordable (and scalable) routes for the high volume synthesis of single and few layer thick graphene flakes, their assembly into micron thick graphene-polyethylene multilayers sheets using ink jet printing and their warm roll-bonding into mm-thick laminates. The laminates will also have a pressure sensing functionality (as a result of their pressure dependent electron tunneling conductance between the graphene layers). Since an aspect of the A2P assembly approach is extendable to other 2D van der Waals bonded materials such as BN, MoS2 etc, the option exists to incorporate many other future functionalities such as piezoelectric energy harvesting into multifunctional laminates. An additional option to the program adds fiber fabrication and polymer pyrolysis/graphitization steps to enable synthesis of a new generation of carbon fibers with strengths approaching 50 GPa, moduli in the 500 GPa range at a density of 1,500-2,000 kgm⁻³; a capability that would revolutionize the design of aerospace structures.

Technical Plan: The recent discovery and ongoing emergence of 2D van der Waals solids such as graphene is set to have a disruptive impact on polymer composites. The huge potential of graphene comes from its unique electrical, optical and mechanical properties. But because graphene can be inexpensively deposited/printed on polymer substrates or embedded into a polymer matrix, new materials with novel combinations of electrical, optical mechanical functionalities could be developed if atom to product approaches for their affordable assembly are developed. This program will develop A2P manufacturing methods for affordable graphene composite synthesis “pulled” by the goal of increasing the ballistic limit of state of the art lightweight composites by a factor of five (i.e. for a given armour mass and projectile, increase the penetration velocity by a factor of five).

It is noted that with relatively small modifications to the assembly sequence, the low process temperature A2P approach developed in the program will be extendable to many other 2D van der Waals material containing composites.

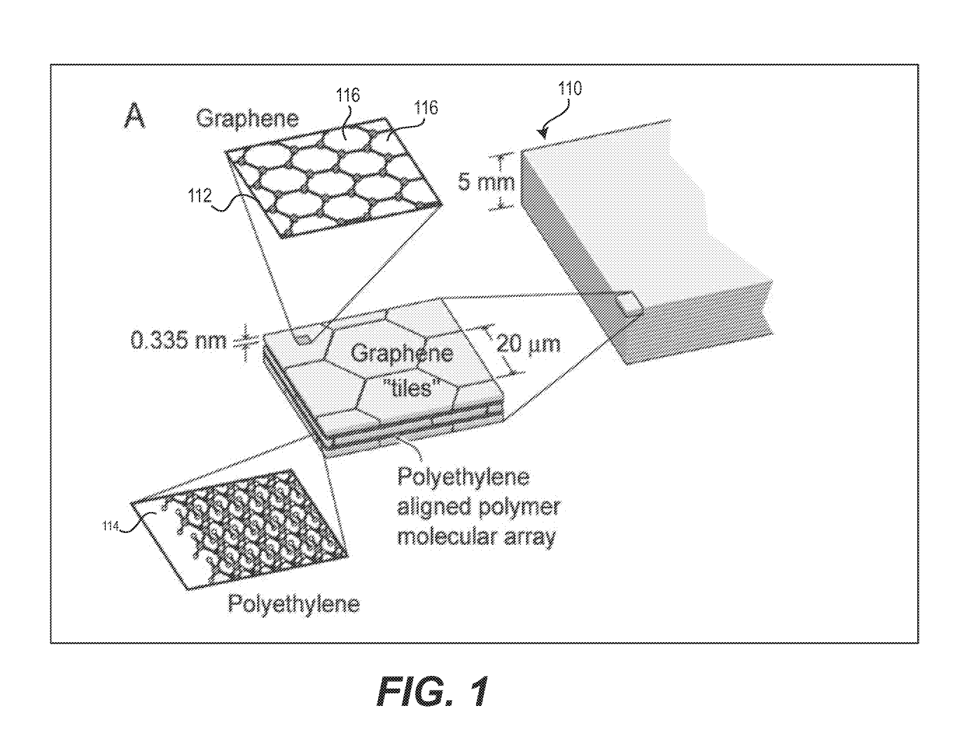

An “ideal” graphene composite 110 is shown in FIG. 1. The composite 110 comprises alternating graphene layers 112 and highly aligned polyethylene monolayers 114. The graphene layers 112 each have a uniform distribution of perfectly aligned graphene flakes 116 (i.e. graphene “tiles”) with a volume fraction V_{f} sandwiched between the highly aligned polyethylene monolayers 114.

For example, the graphene composite can have a thickness of 5 mm and the graphene layers 112 can have a thickness of 0.335 nm (nanometers). The width of the grapheme flakes 116 can be 20 μm (micrometers).

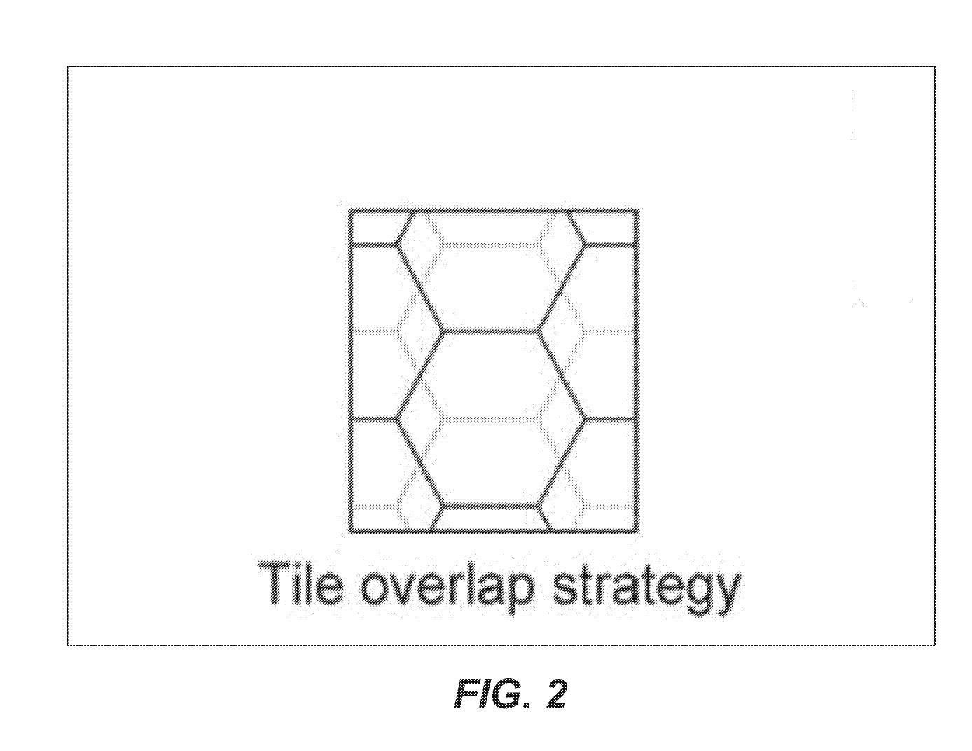

As shown in FIG. 2, consecutive graphene layer 116 are arranged with the graphene flakes 116 overlapping each other as shown. Specifically, the center of the graphene flakes 116 of a first consecutive graphene layer 116 are centered over the border or joint of adjoining graphene flakes 116 of a second graphene layer 116 (i.e. full or optimum overlapping arrangement). Alternatively, the phase of overlapping between consecutive graphene layers 116 can be varied to be different or vary along a length of the composite (e.g. tailoring overlapping).

The graphene flakes 116 have in-plane dimensions L and thickness of one atomic layer denoted by t. The tensile strength of the graphene flake is σ_{f} while the shear strength of the interface between the graphene and the polymeric matrix is τ_{Y}.

Now load this composite 110 in tension co-linearly with the plane of the flakes. The tensile stresses are transmitted into the graphene flakes via shear at the interfaces with the polymer. A simple shear lag analysis then specifies that the flake size needs to satisfy the condition

$$L \geq \frac{{σ}_{f}}{2 {τ}_{y}} t$$

so as to achieve failure of the composite via flake fracture rather than flake pull-out by shear at the interfaces between the polymer and graphene. Taking τ_{Y}−3 MPa, σ_{f}−120 GPa and t−3 Å, we get L≧6 μm. It follows that the tensile strength of the composite is σ_{f}V_{f} and the tensile modulus is E_{f}V_{f}, where E_{f}=1 TPa is the modulus of the graphene flakes (as the strength/modulus of the polymer are much less than graphene).

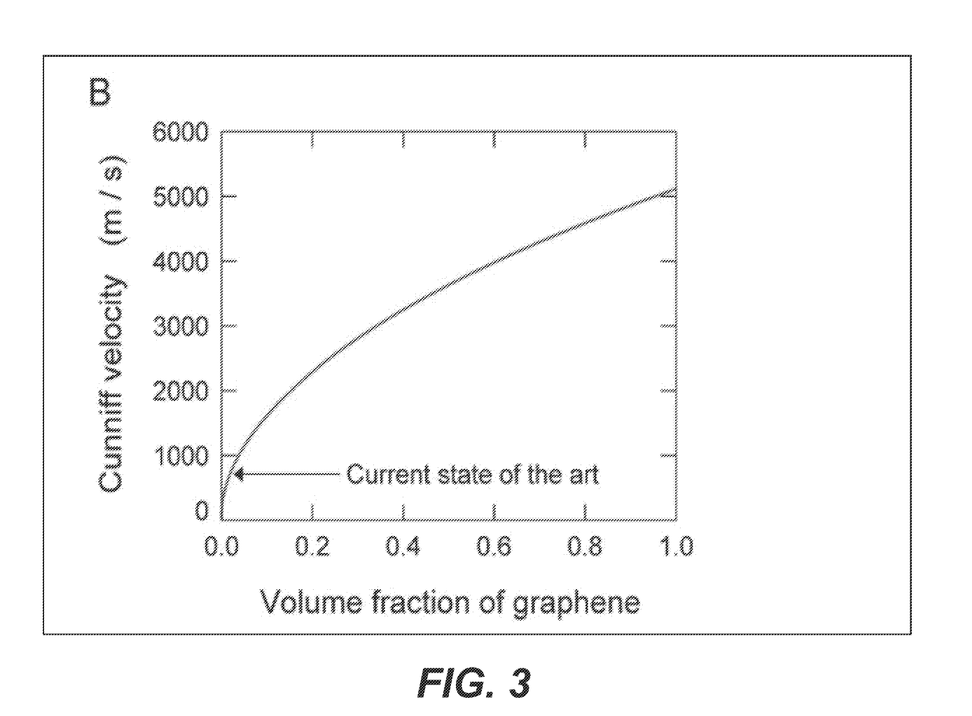

The predictions of the Cunniff velocity versus volume fraction of graphene is shown in FIG. 3.

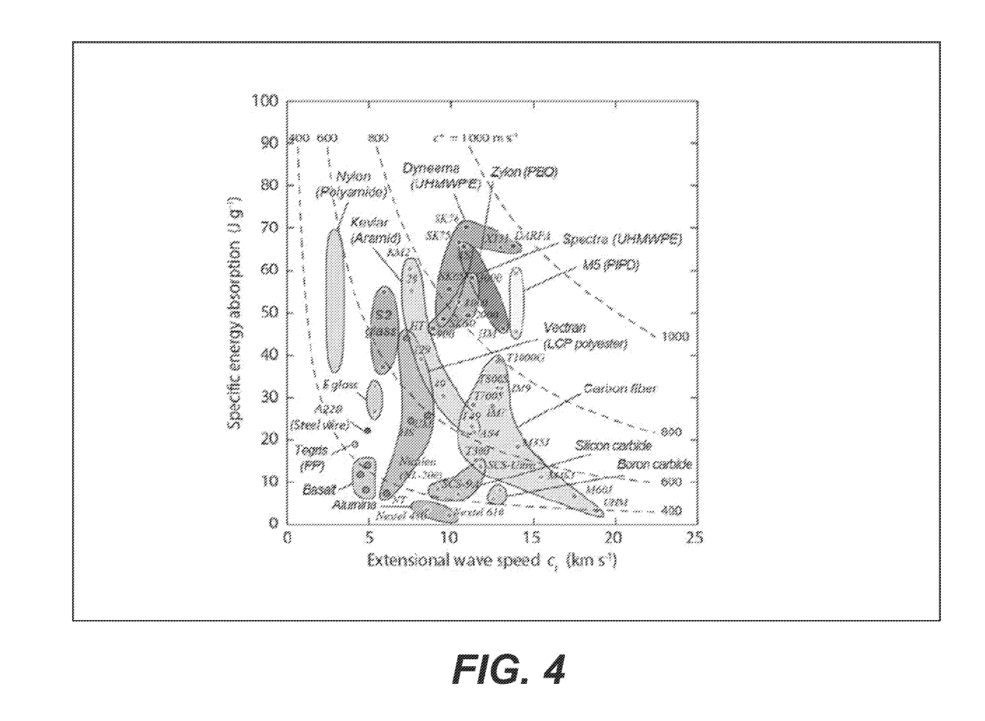

A major step in prediction of the ballistic performance of fiber composites was the observation by Cunniff that the critical velocity for penetration of armour fabrics by a projectile scales linearly with the Cunniff velocity

$${c}^{*} ≡ {( \frac{{σ}_{f} {ɛ}_{f}}{2 ρ} \sqrt{\frac{E}{ρ}} )}^{1 / 3}$$

where σ_{f} and E are the fibre strength and modulus, respectively, a_{f}≡σ_{f}/E is the failure strain and ρ the density of the fiber. The velocity c* depends on the product of specific energy absorption and wave speed of the fibres and hence all known fibres are plotted using these axes, as shown in FIG. 4.

It is clear that ultra-high molecular weight polyethylene (UHMWPE) fibres (commercially known as Dyneema) are the best systems to-date with c*≈900 m/s. UHMWPE composites made from these UHMWPE fibres have a high tensile strength (around 2 GPa), but low shear strengths on the order of 2 MPa. These low shear strengths have been shown to be advantageous in ballistic applications, since they inhibit the usual mechanisms (comminution, radial and circumferential cracking) of penetration. But they are very poorly suited for structural load carrying applications where a high shear strength is an essential requirement.

The Cunniff velocity of a weak shear strength graphene composite as a function of the volume fraction of graphene is shown in FIG. 3. A composite with a graphene fraction of 50% will have a c*≈5500 m/s. This is well off the chart shown in FIG. 4, and would revolutionise future armour designs. The specific energy absorbtion and elastic wavespeed of various fibers for ballistic impact applications. The DARPA developed fiber in HB 212 Dyneema is the current state of the art.

The A2P manufacture approach is the key to the manufacture of large scale composites with controlled nano-scale graphene features. The A2P program shown in FIG. 5 combines both atoms to micron (TA1) and micron to millimetre A2P manufacture (TA2) in combination with computational modelling and measurement/characterization efforts aimed at ensuring the manufacturing approach delivers the key material state control parameters that are driving performance at the atomic, nano and micro length scales.

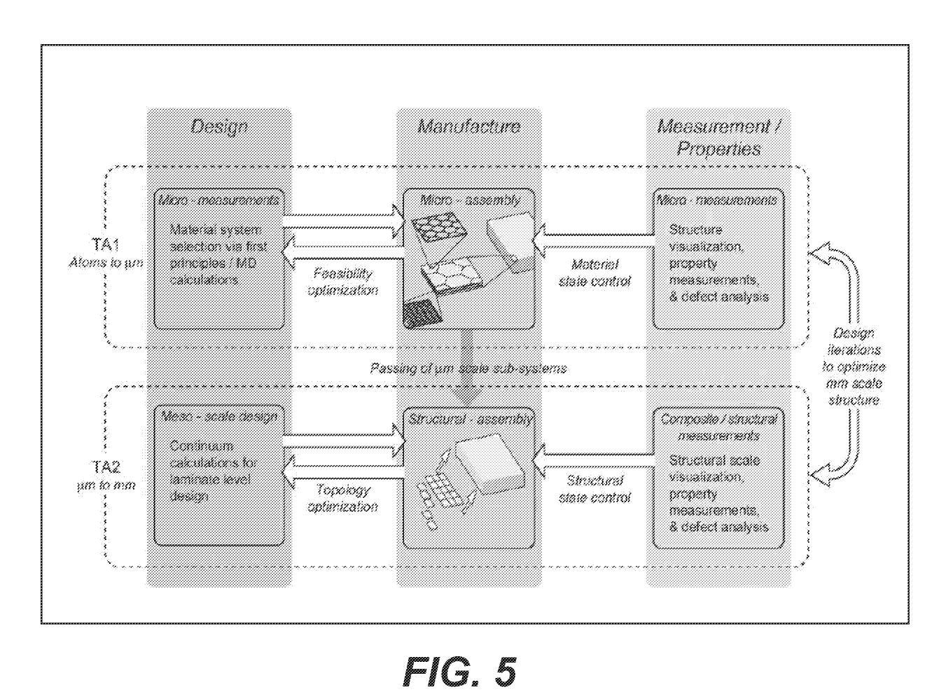

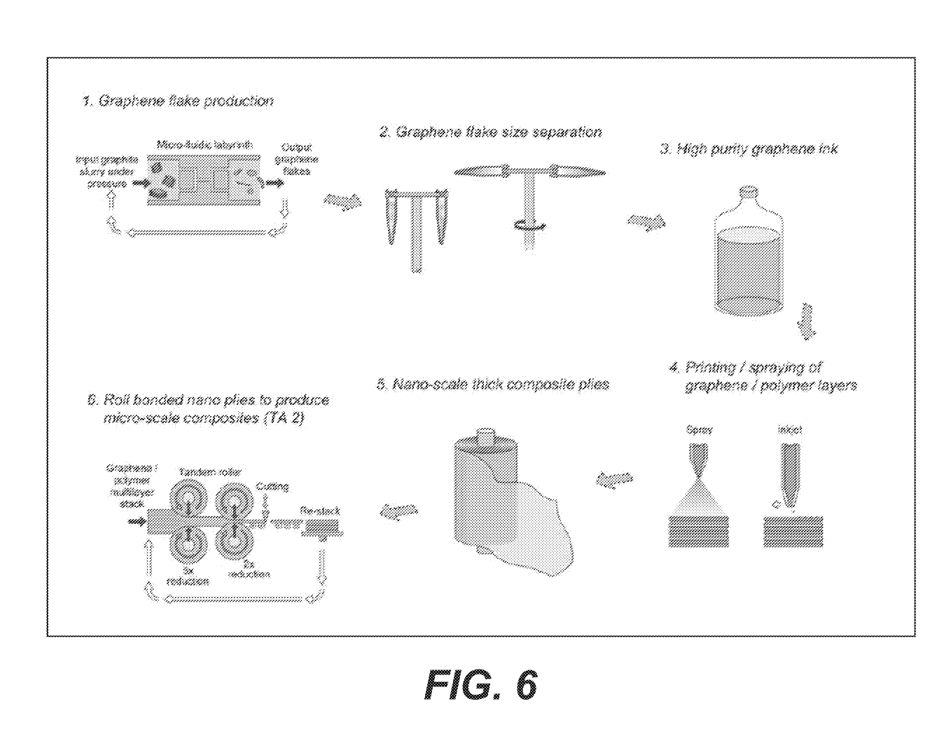

A schematic view of the A2P assembly sequence is shown in FIG. 6. It involves, but not limited to three (3) exemplary steps: (I) Atomic scale graphene flake production (steps 1-3); (II) nano-scale polymer/graphene ply production (steps 4 and 5), and (III) micro/mm scale composite production (step 6). Included is the micro/mm scale composite production from the nano-scale feedstock (step III), for example. It is pointed out that there are numerous options for each of the three manufacturing steps with advantages and disadvantages as summarised below. There exists the capabilities to implement, but not limited thereto, all of these processes. A combination of approaches can be developed to control the material state, production rate, and ultimate material cost; all consistent with design requirements.

Step I: Graphene flake production (Table 1): Graphene flakes can be assembled from the vapour phase by CVD on copper templates but is very costly. More affordable techniques range from liquid phase exfoliation of previously assembled coarse grained graphite, which has the high control of the flake state but low production rate to micro-fluidic exfoliation that has a high production rate but low state control.

Step II: Nano-scale ply production (Table 2): Again techniques range from the high production rate micro-extrusion technique with minimal control over flake alignment to the relatively lower production printing techniques with significantly more control of flake alignments but resulting in rough films.

Step III: Nano-scale to mm-scale composite production: A temperature and shear strain rate optimized tandem roll-bonding and laminate thinning process will be developed to assemble the final laminates from vertically stacked ink jet printed submicron thick films (step 6). The process enables 10× thickness reductions for up to 100 sequential rolling steps to achieve the final nanoscopically tailored structure, with the number of rolling stages dictated by the thickness of the graphene layers after TA1 processing. In situ sensing will be used throughout all steps of the A2P process to implement feedback control of the primary process steps. There can be program options to convert the micron scale tapes (TA11 product) into a circular format fiber (with a multilayer ring structure) to create a revolutionary ultra-strong (order 50 GPa) carbon fiber with a modulus of 500 GPa and addition of other 2D molecules for tailoring multifunctionality.

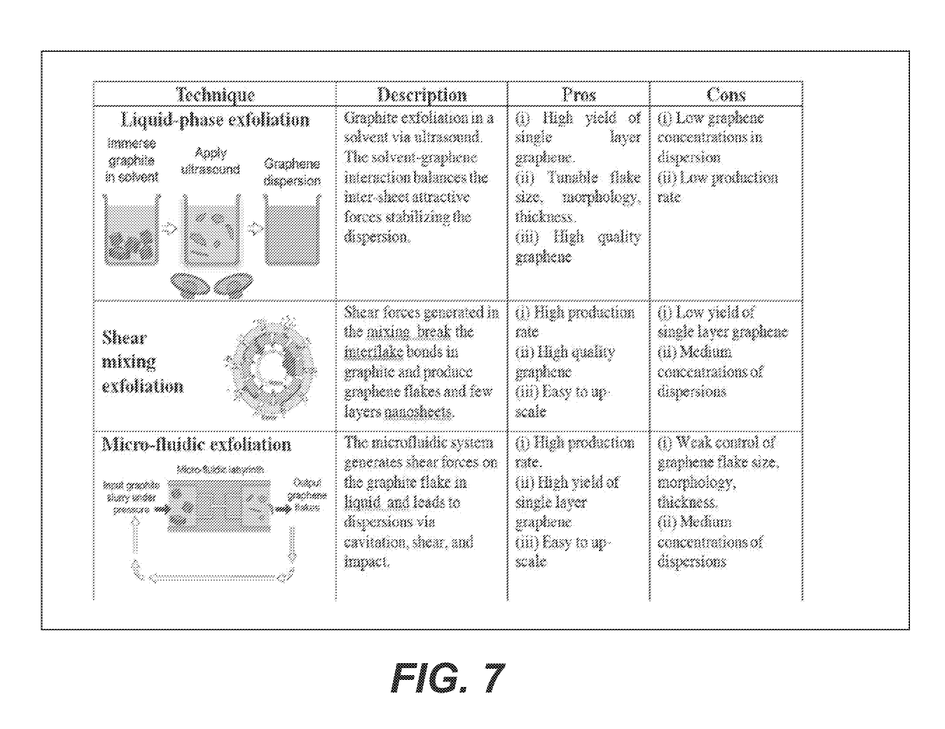

Various production techniques for grapheme flake production, and pros and cons thereof, are shown in FIG. 7. The techniques, include 1) liquid-phase exfoliation; 2) shear mixing exfoliation; and 3) micro-flake exfoliation.

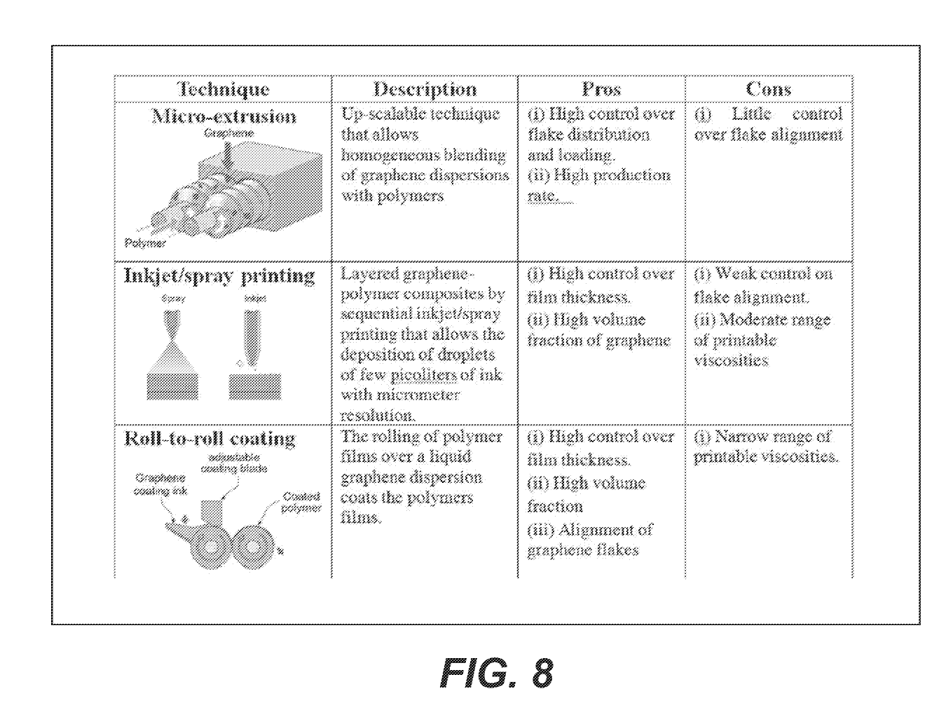

The production of nano-scale graphene composite plies, and the pros and cons thereof, are shown in FIG. 8. The production, include 1) micro-extrusion; 2) inkjet/spray printing; and 3) roll-to-roll coating.

### Integrated Computational Design and Measurements

An integrated computational materials engineering (ICME) consistent with the Materials Genome Initiative and complimentary experimental effort will be an inherent part of the program to optimise/tune the manufacturing routes to achieve the material state control required to achieve the performance metrics of stiffness and strength.

Being one atom thick, the effect of graphene upon the properties of the composite at the nanoscale are difficult to elucidate by experimental analyses alone. Molecular dynamics (MD) simulations allow the graphene/polyethylene composite to be created on an atomic scale and the response of the material to the external loads can then be numerically examined in great detail. The evolution of frictional forces at the graphene/polyethylene interfaces, stress tensors at the point of each atom, deformation, defect creation, fracture, thermal transport, etc. can all be directly analyzed from atom positions and velocities, and provide guidance to process improvements (i.e. introduction of functional groups to the graphene surface to increase the shear strength).

Continuum mechanics design tools will continue to be developed to optimize ply architectures at the micro-scale (e.g. laminates versus weaves, ply orientations, thicknesses etc.). Penetration, micro-scale impact and tensile tests will be used to the composites and compared with predictions.

### EXAMPLE

An atoms to product (A2P) approach to assemble carbon atoms to form 10 mm diameter graphene flakes, and then atomically separate them with a polymer monolayer within a large (mm) scale laminate, potentially in combination with other 2D Van der Waals materials to create a multifunctional composite with a ballistic resistance 5× that of today's state of the art.

A scalable A2P approach for the assembly of multilayer graphene (and/or other vdW solids) with polymers yielding atomic scale phase separation has been identified. It involves six simple steps with steps 1-5 consistent with TA1 and a warm roll-bonding method used for final assembly (TA12).

Materials exhibit different and potentially useful characteristics when fabricated at extremely small scales—that is, at dimensions near the size of atoms, or a few ten-billionths of a meter. These “atomic scale” or “nanoscale” properties include quantized electrical characteristics, glueless adhesion, rapid temperature changes, and tunable light absorption and scattering that, if available in human-scale products and systems, could offer potentially revolutionary defense and commercial capabilities. Two as-yet insurmountable technical challenges, however, stand in the way, such as but not limited thereto: Lack of knowledge of how to retain nanoscale properties in materials at larger scales, and lack of assembly capabilities for items between nanoscale and 100 microns—slightly wider than a human hair.

Graphene has a strength of more than 100 GPa, a modulus of 1 TPa and a density of ˜2,000 kgm⁻³. If combined with a polymer to preserve out of plan VdW bonding, the resulting laminate is predicted to have a strength of 10× that of current ballistic materials with additional functionalities such as pressure sensing or piezoelectric response possible—especially when other VdW materials are incorporated.

It should be appreciated that current blending approaches have only been able to make dilute composites with no more than 2% graphene content in which the graphene flakes are randomly oriented and distributed (and frequently poorly dispersed). While they improve the strength and modulus of the polymer, they have poor performance compared to competing materials.

Nanocomposite tensile strength 5× above all existing fibers and modulus of 500 GPa leads to ballistic limit (Cuniff velocity) predictions 5× higher than DSM Dyneema HB 212 (using DARPA fiber).

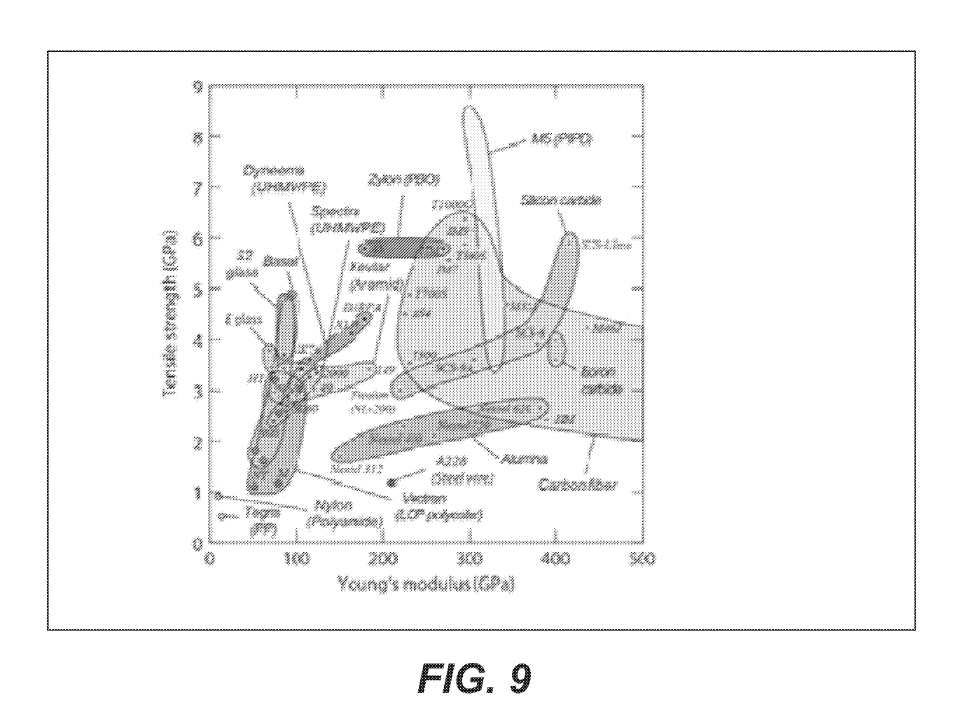

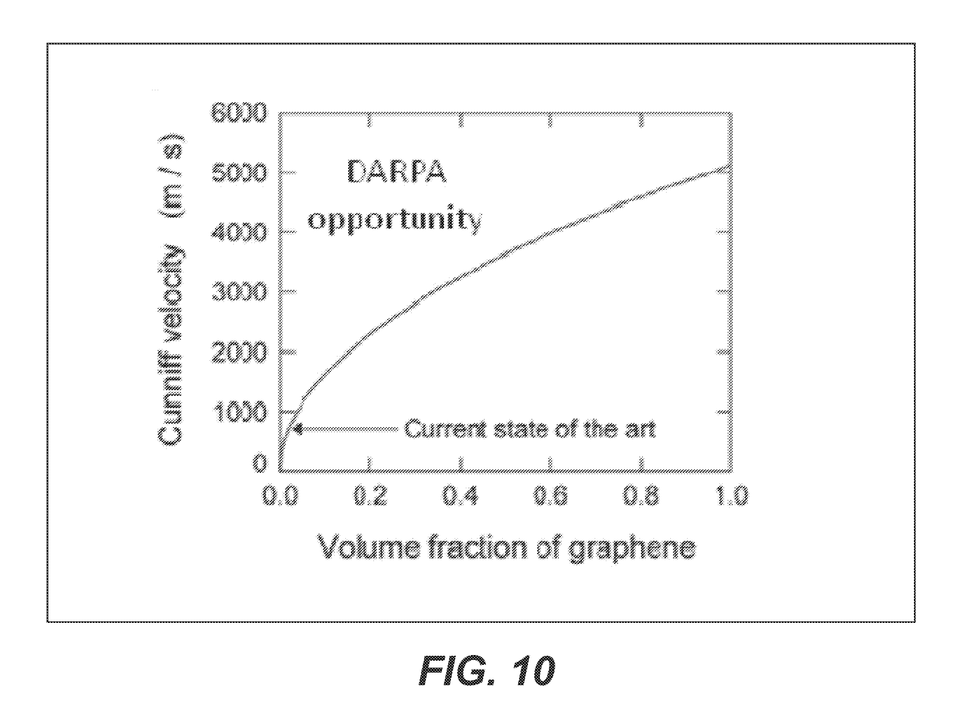

A graph of tensile strength verses Young's modulus is shown in FIG. 9. Further, a graph of Cunniff velocity verses volume fraction of graphene is shown in FIG. 10.

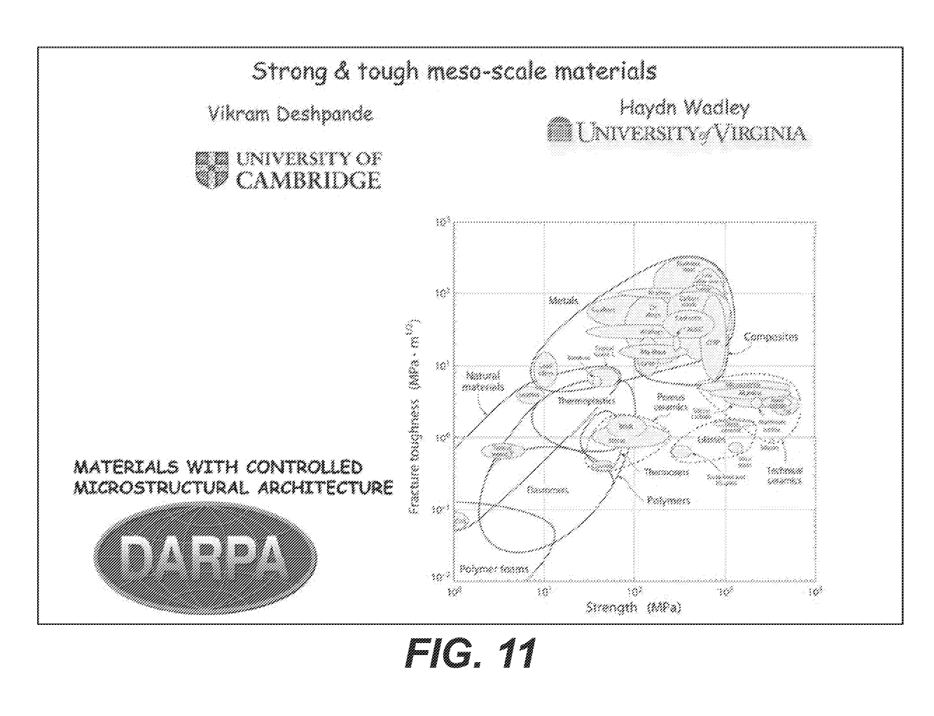

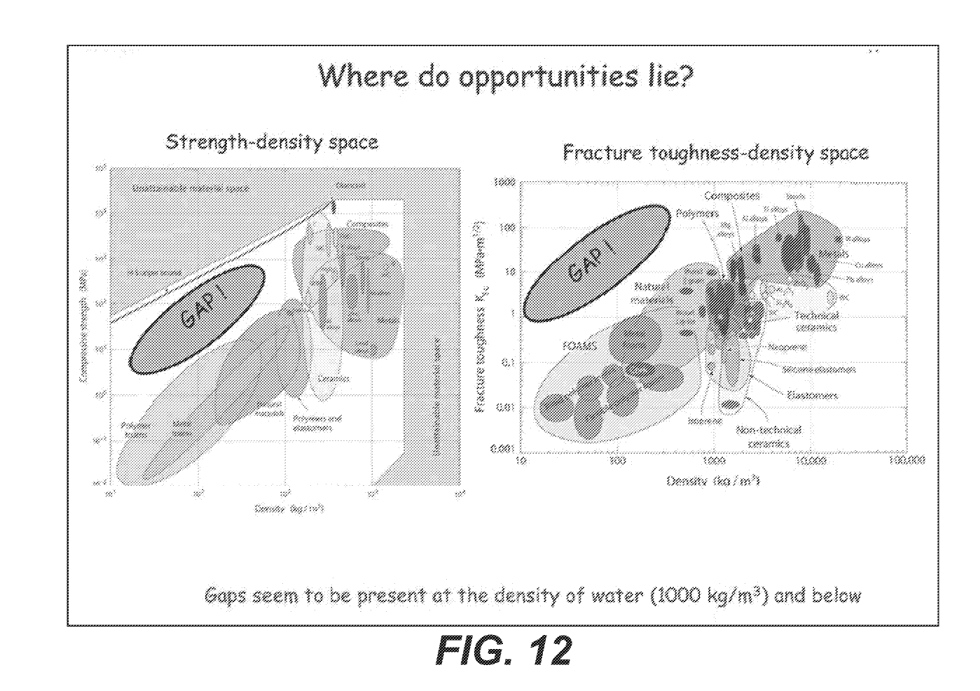

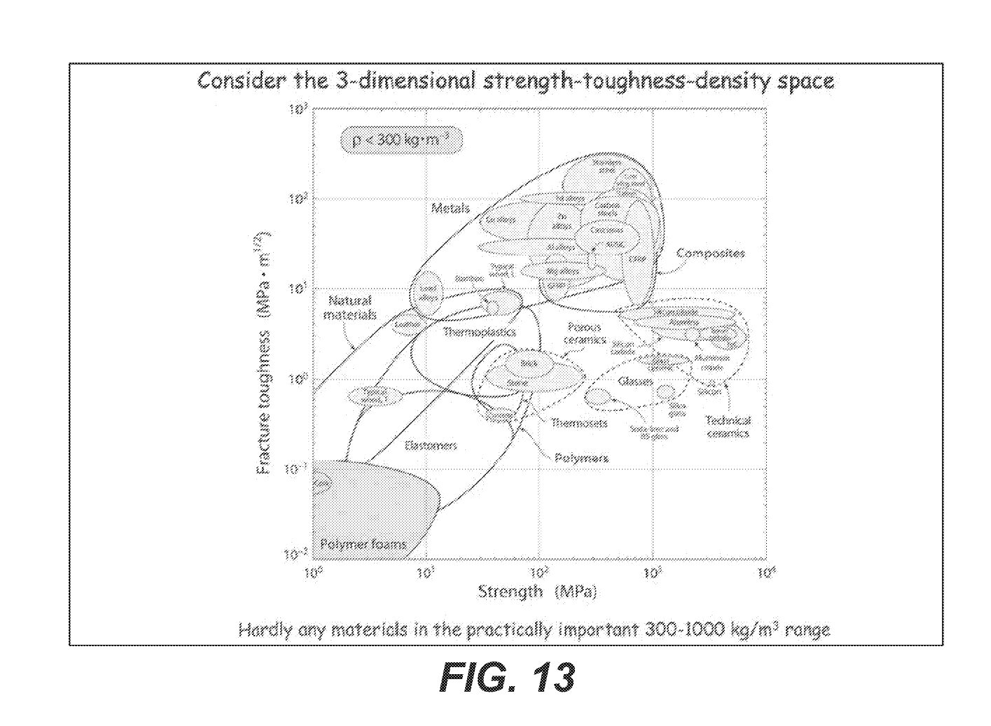

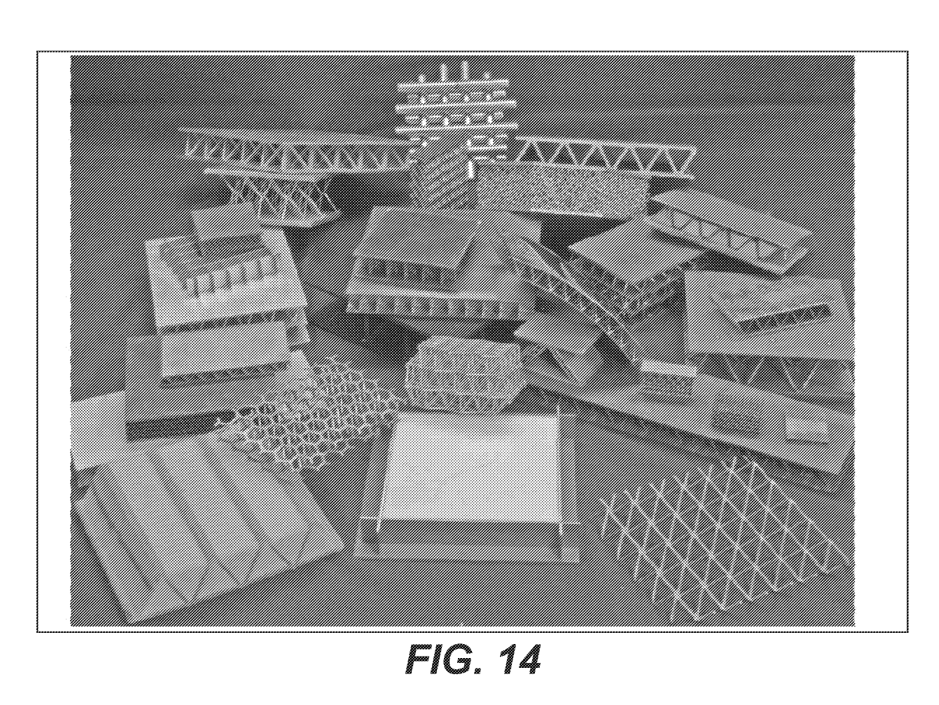

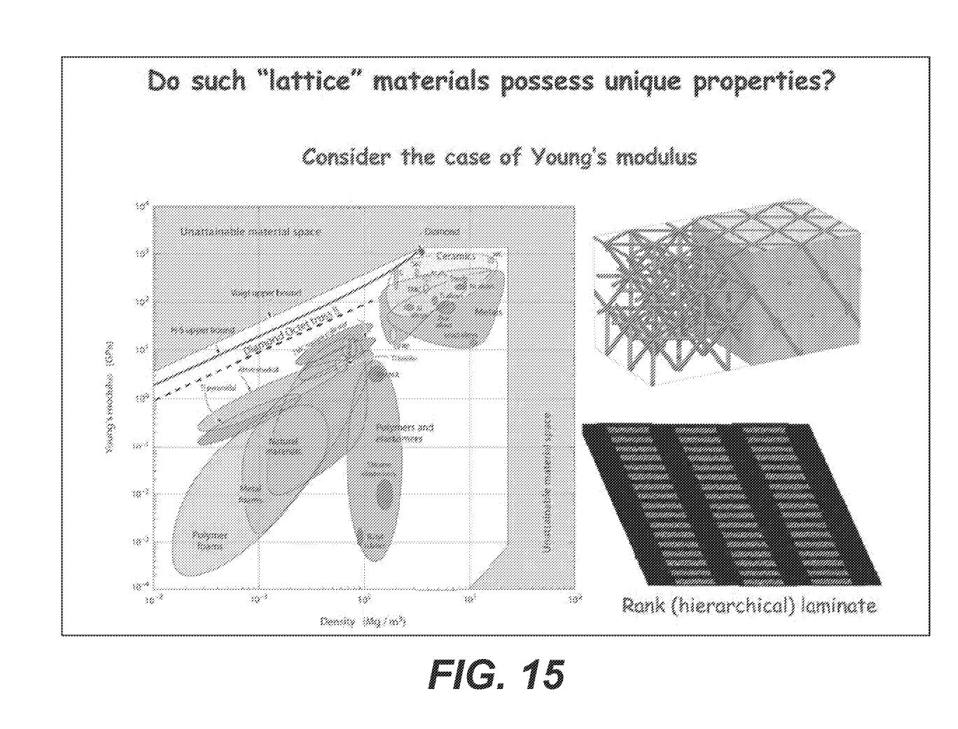

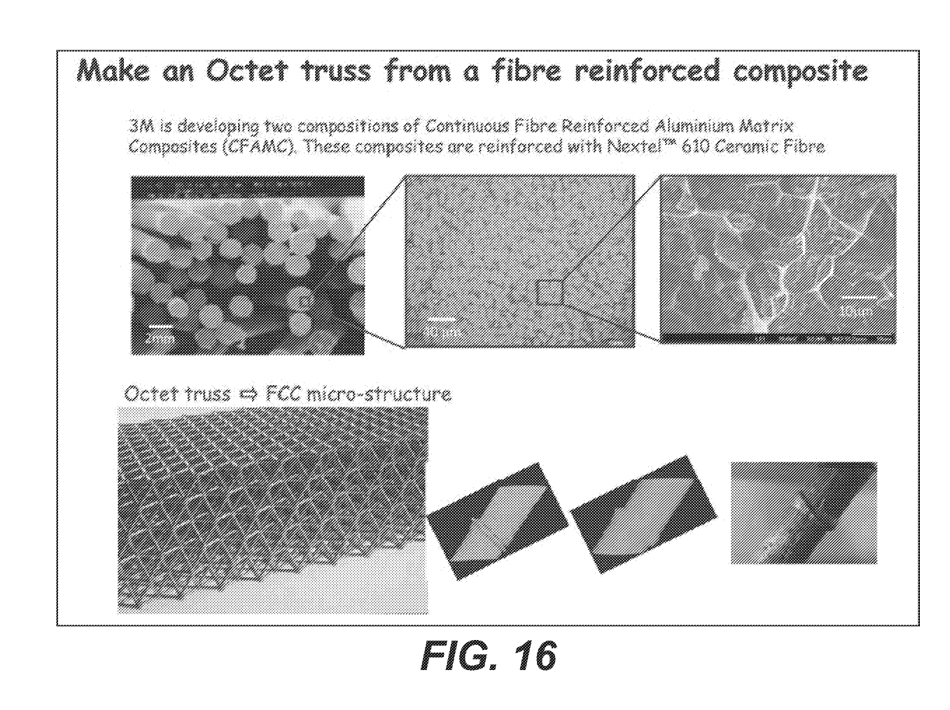

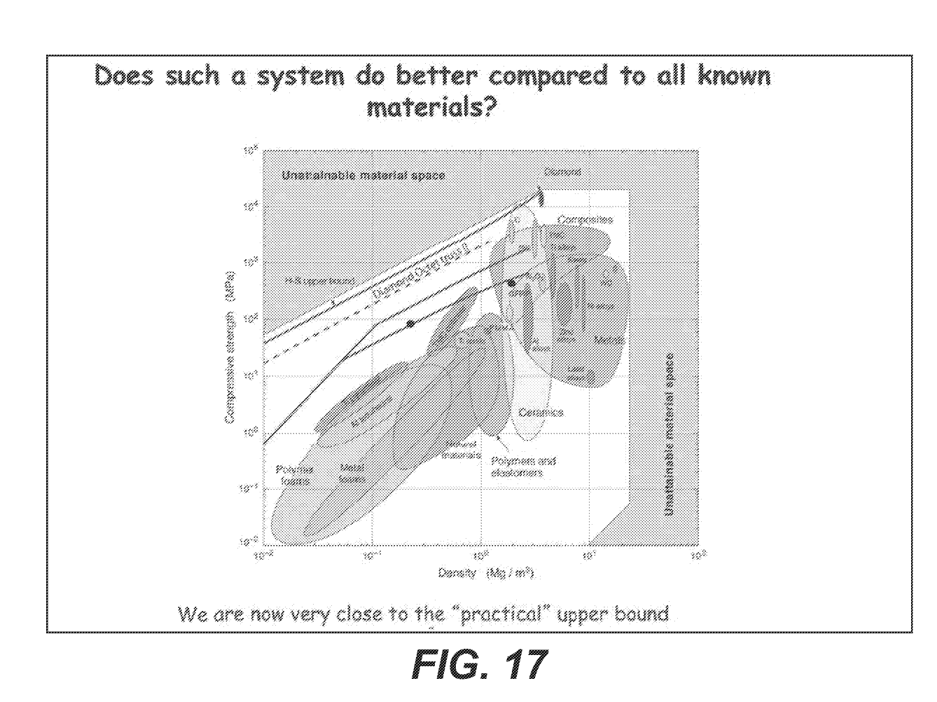

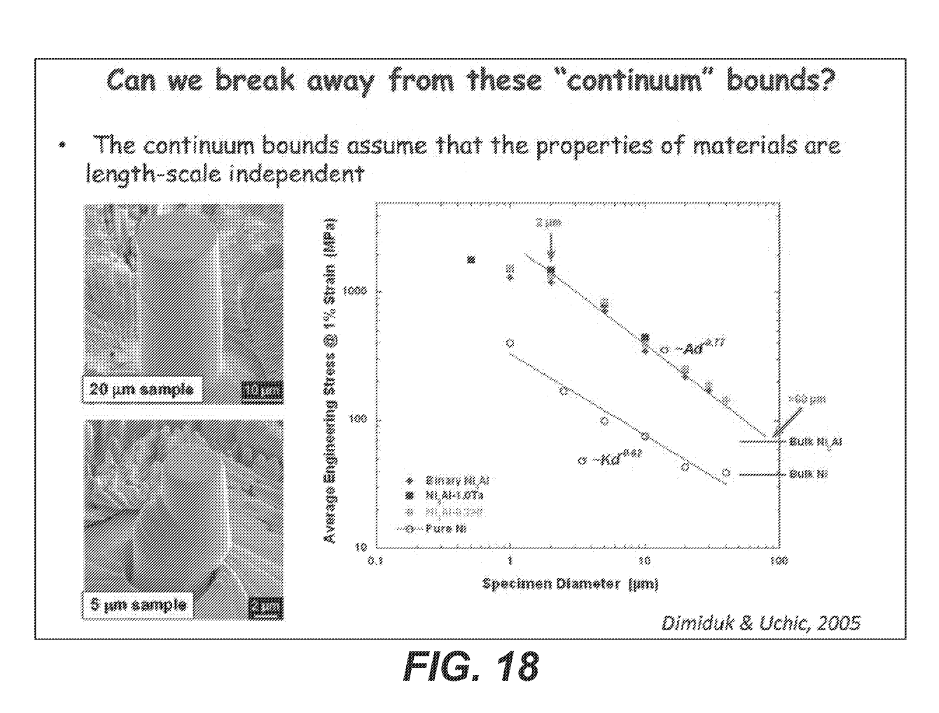

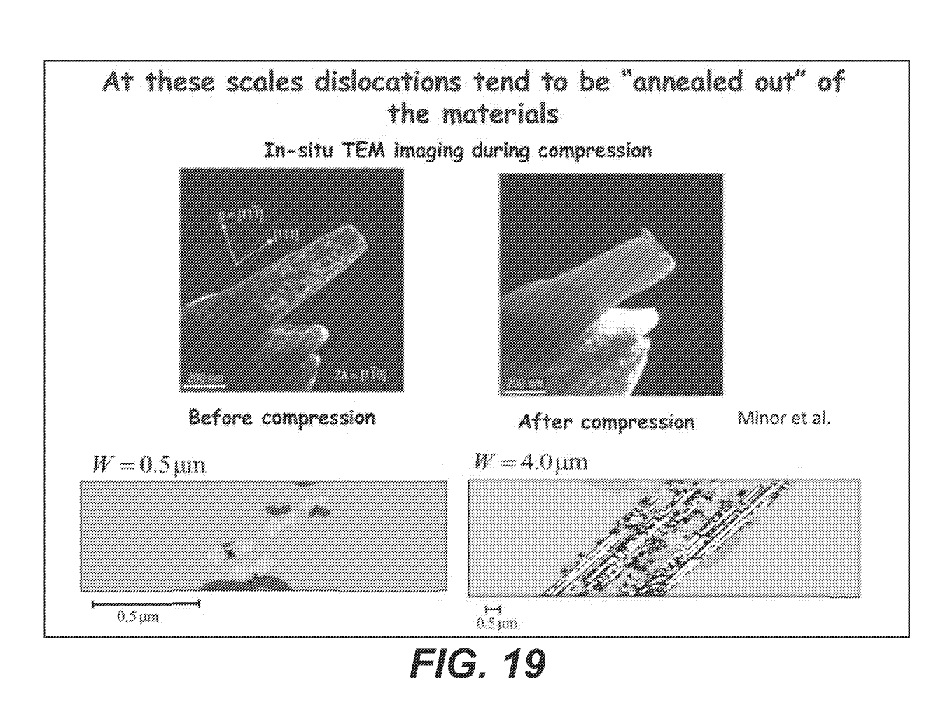

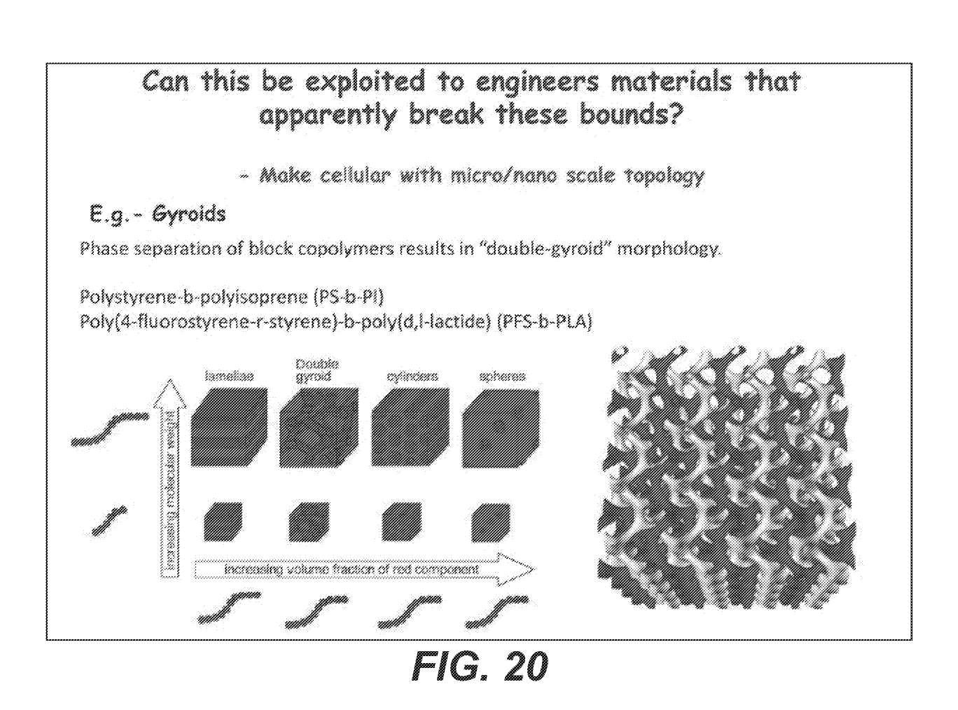

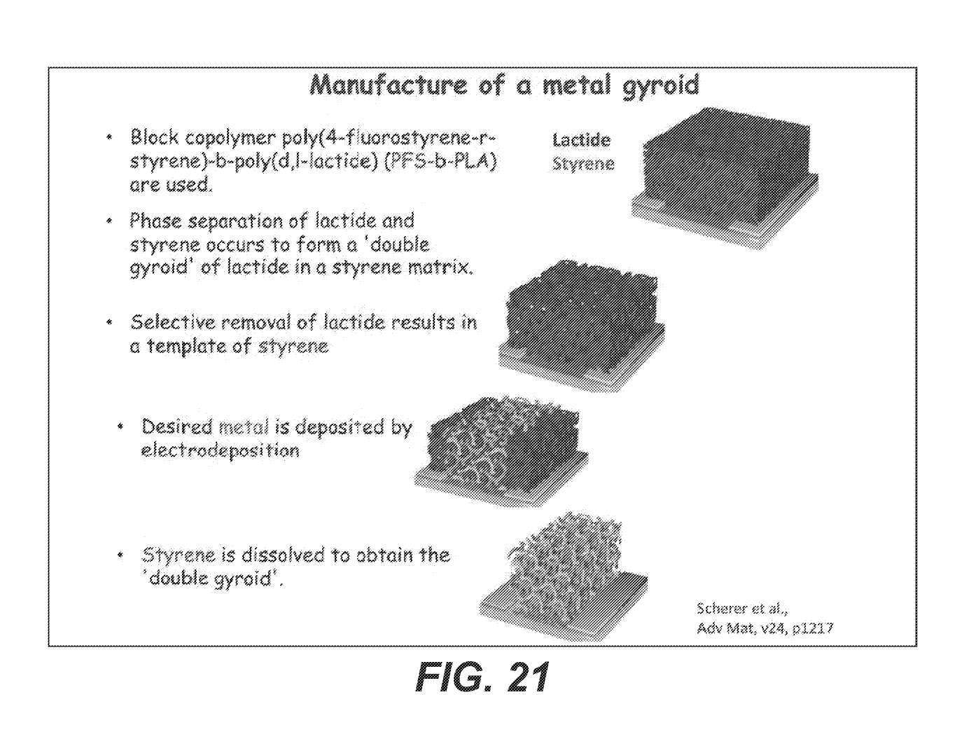

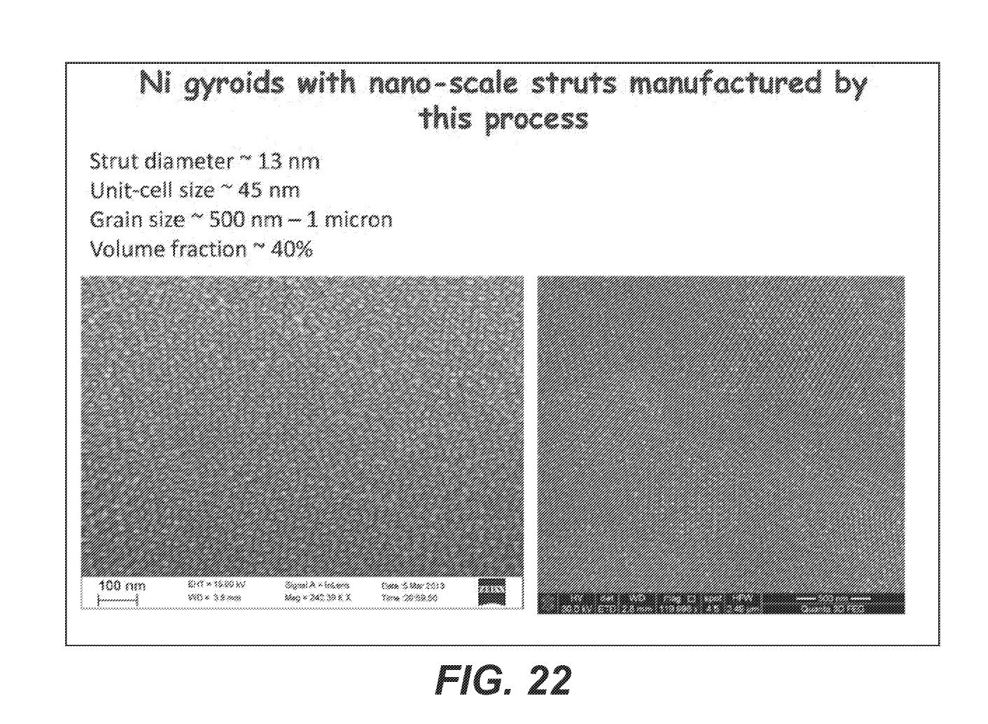

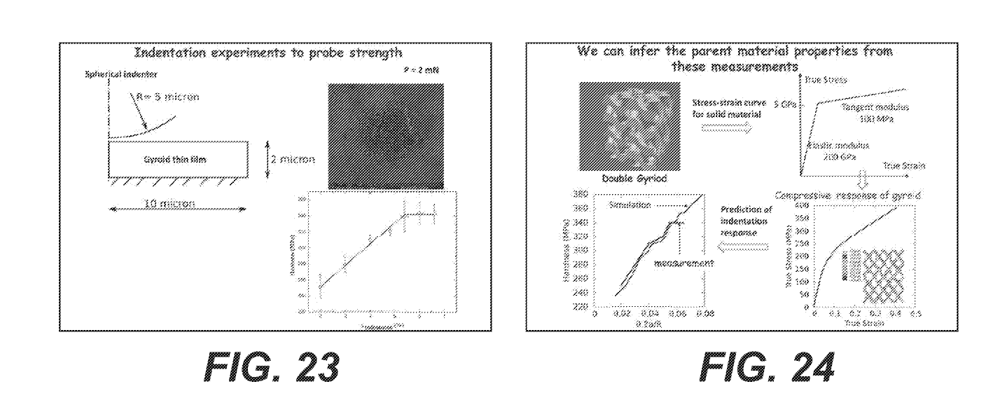

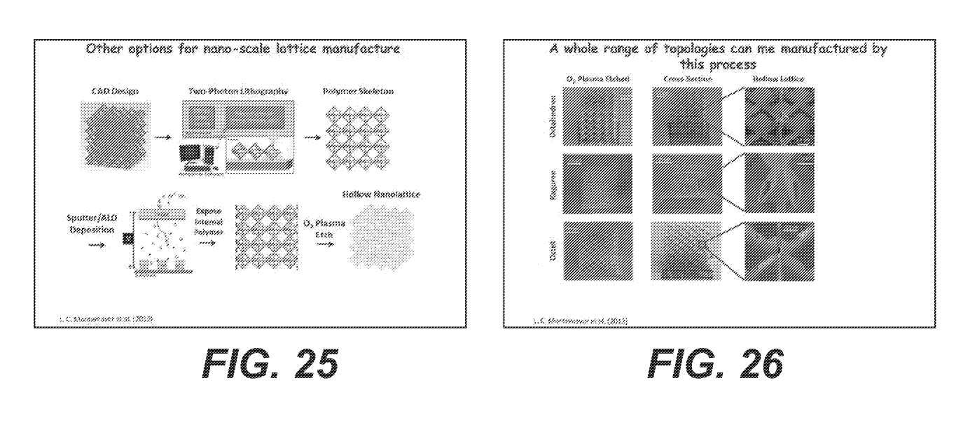

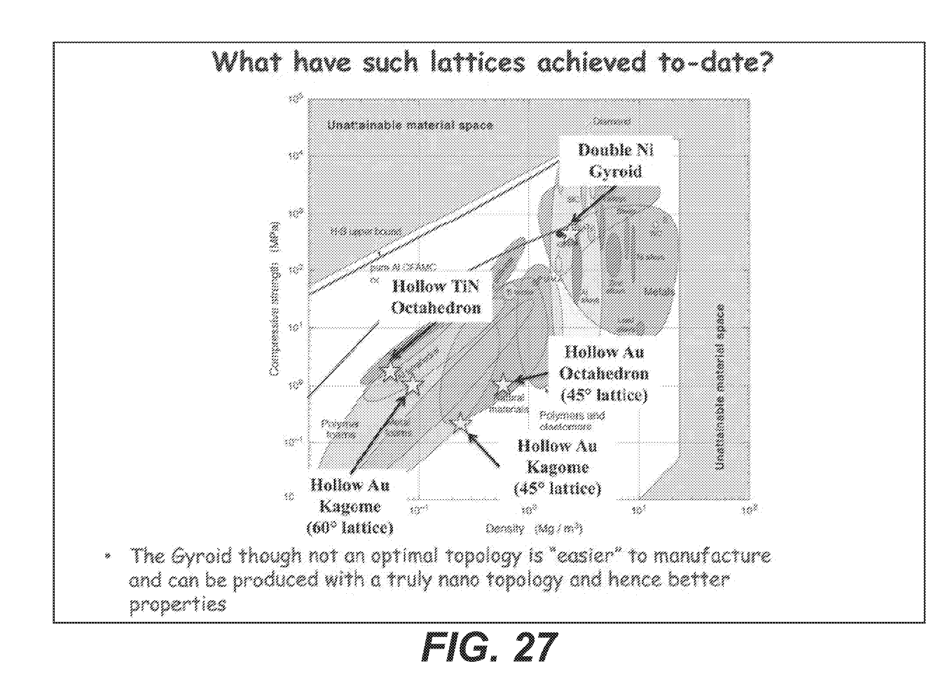

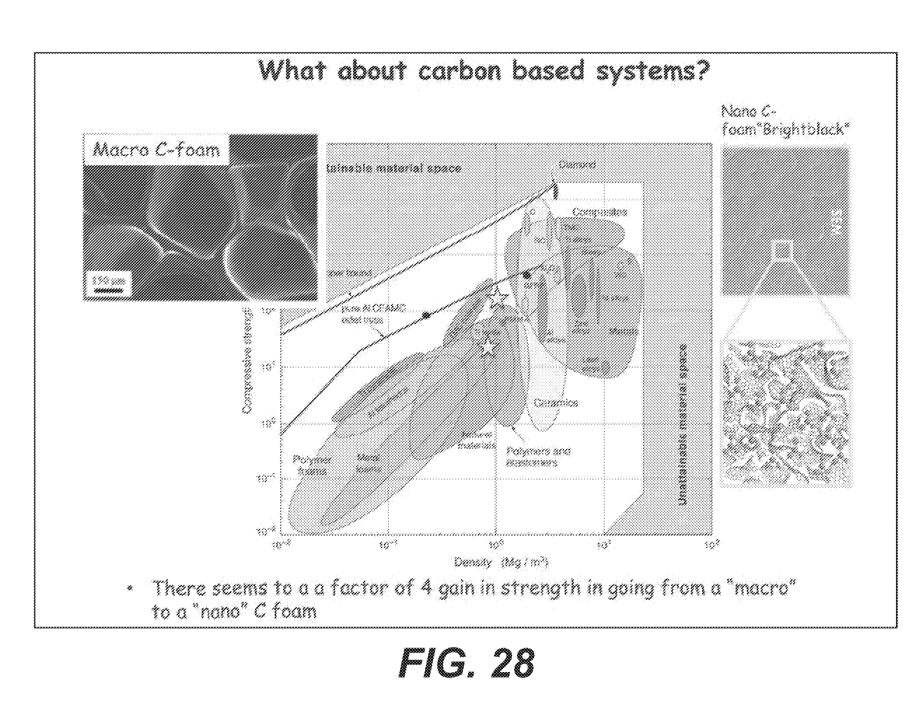

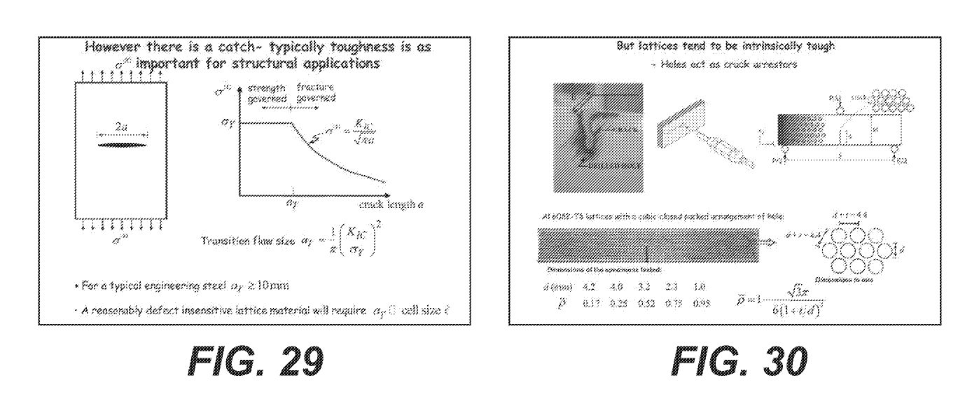

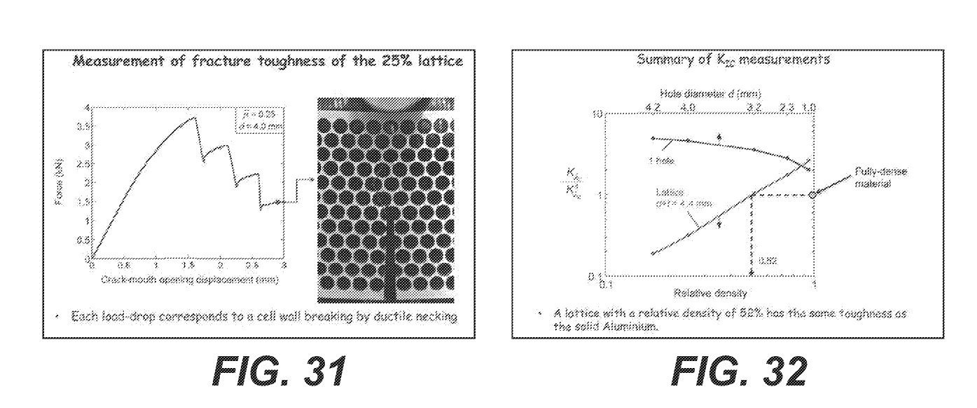

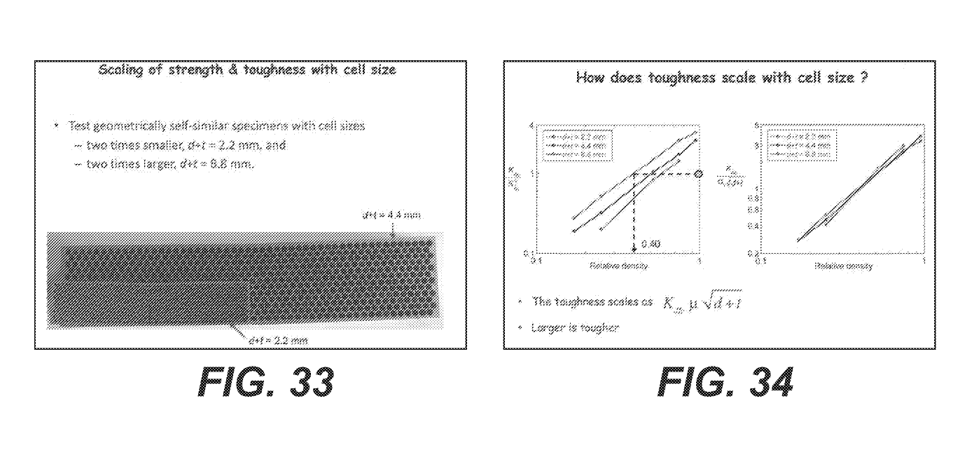

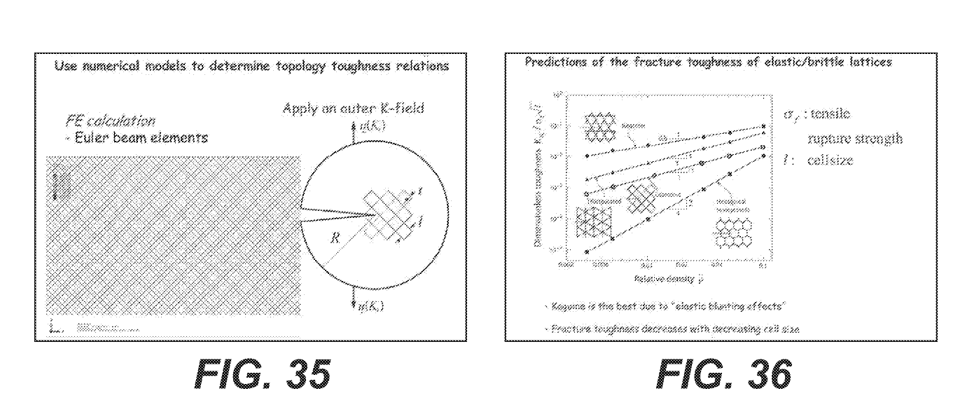

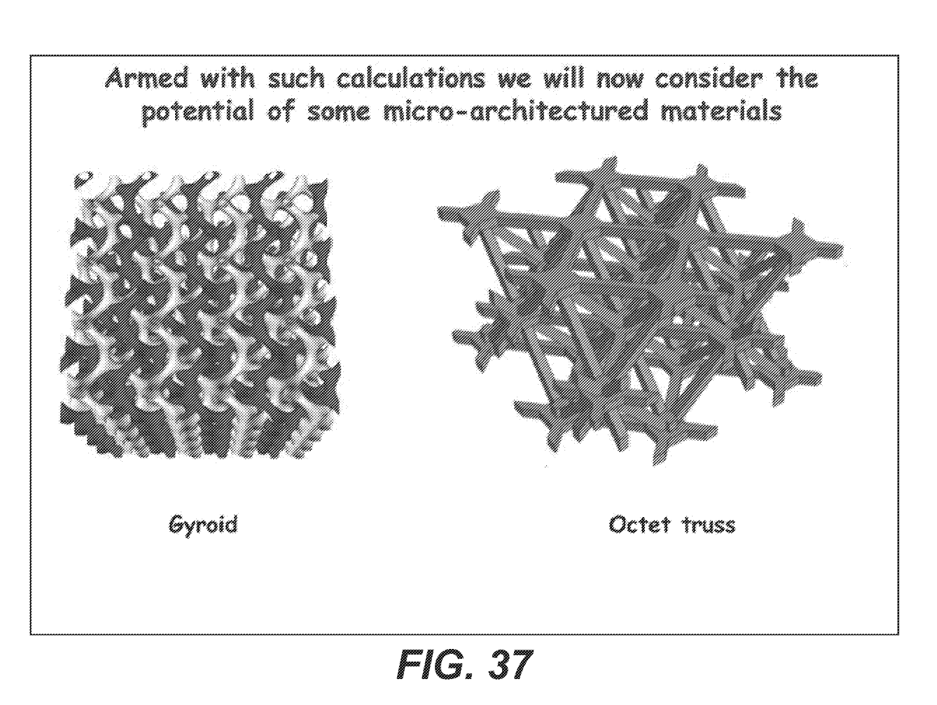

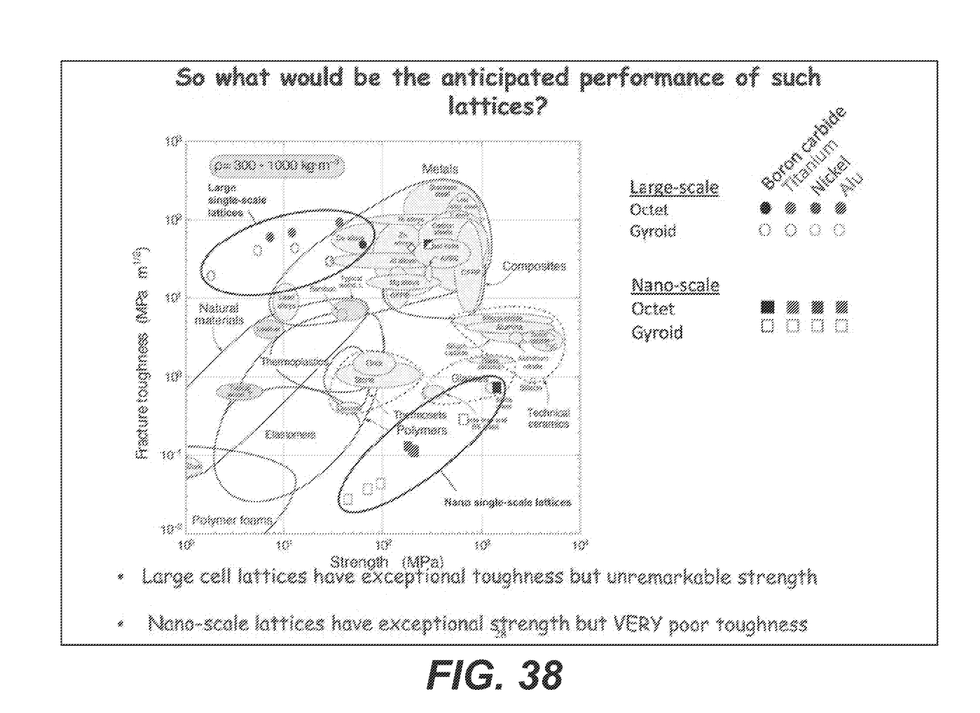

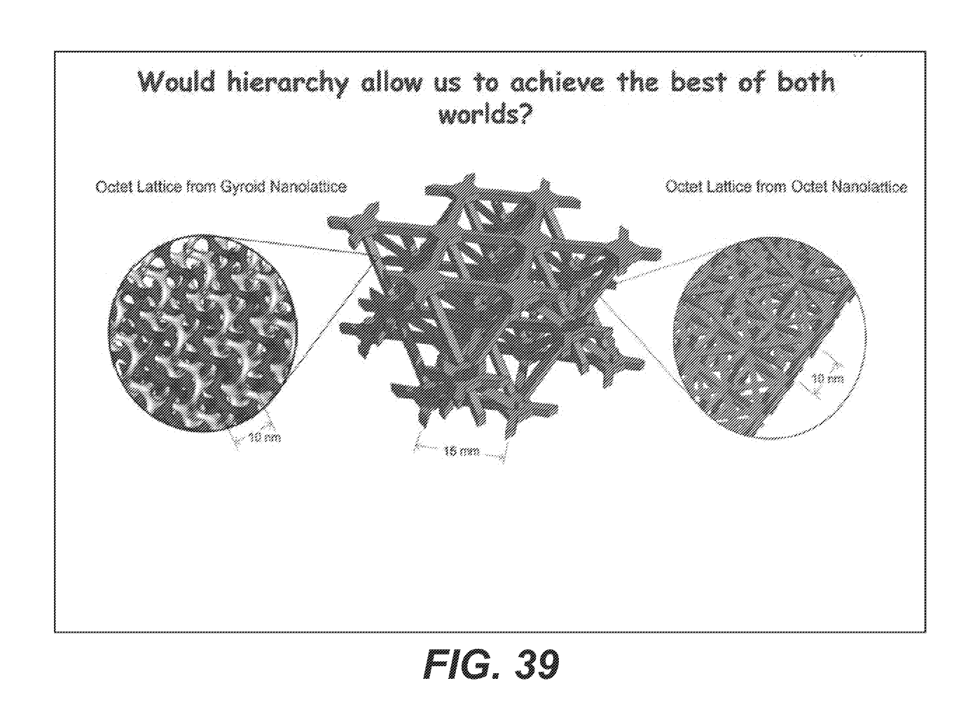

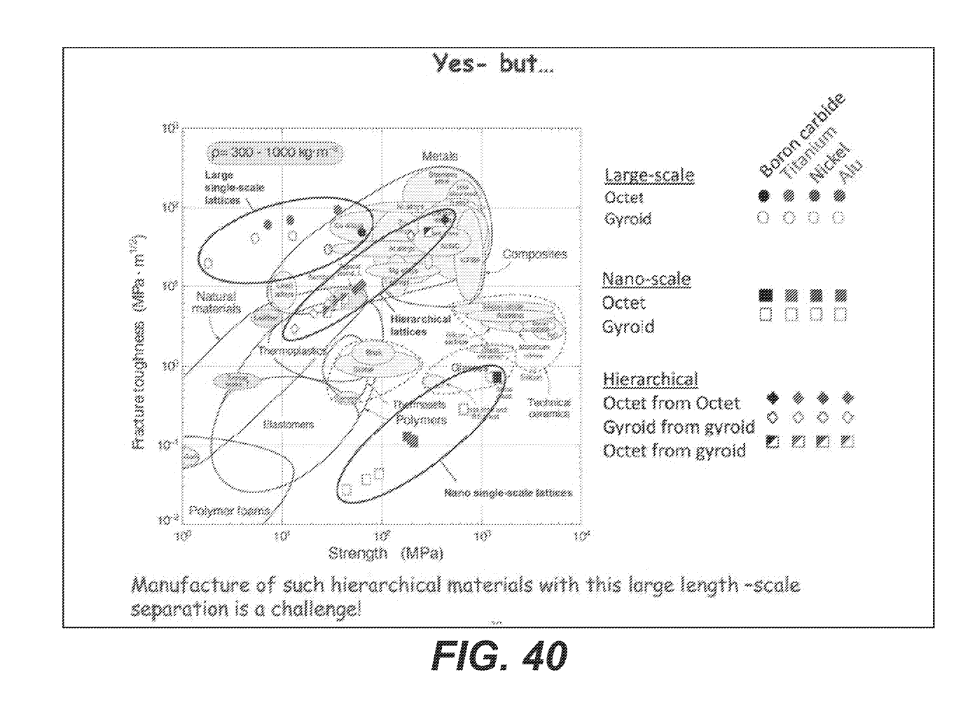

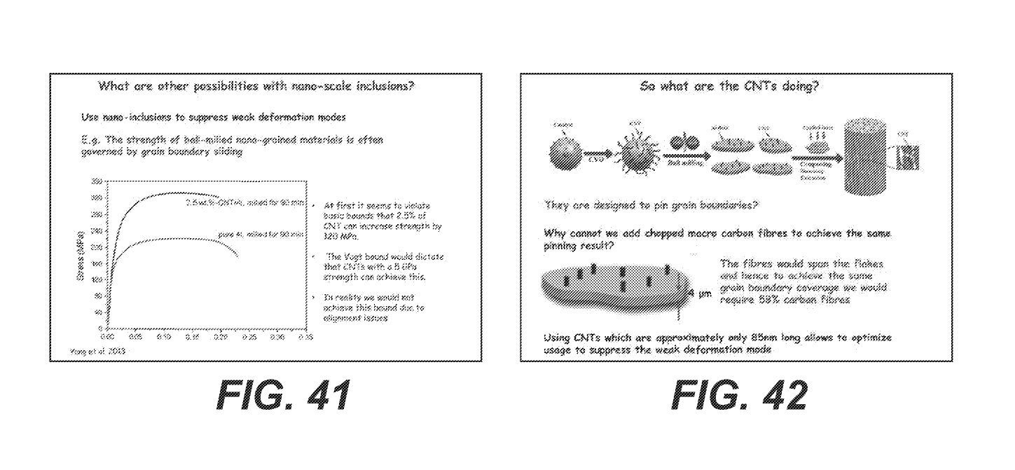

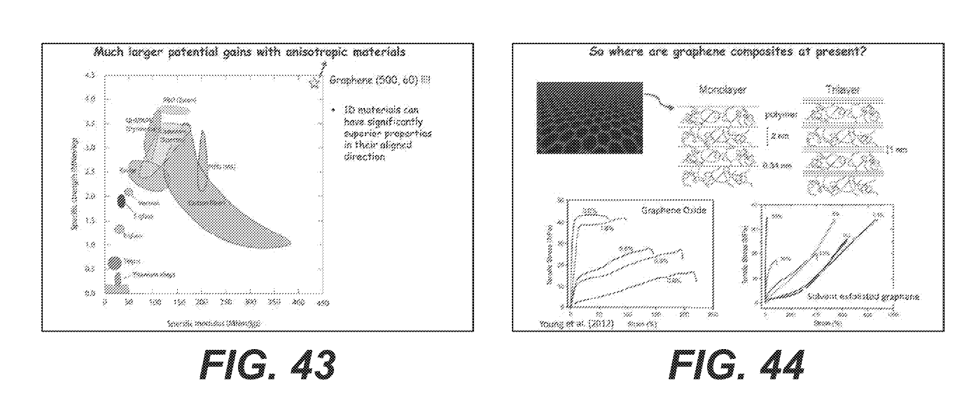

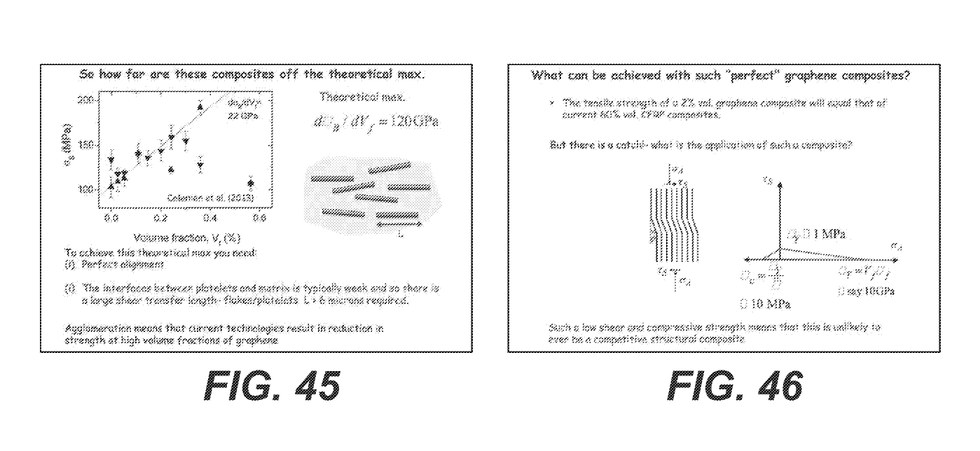

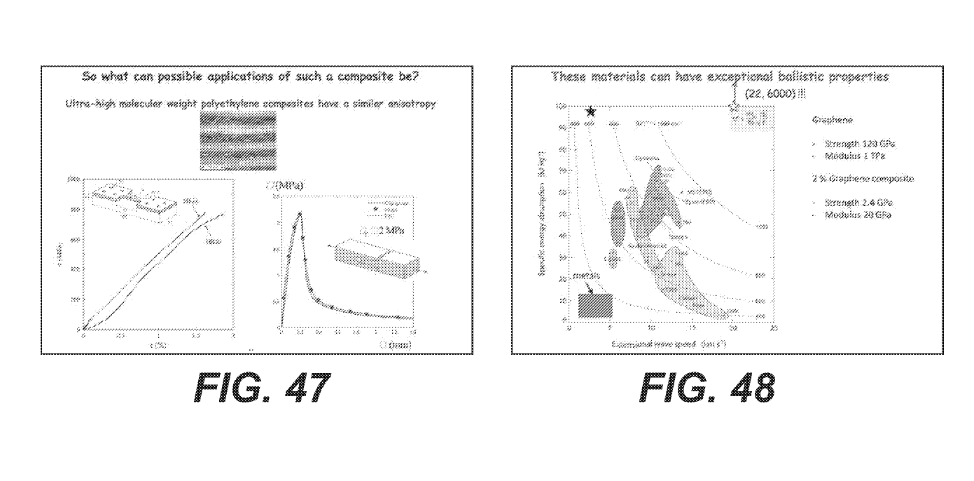

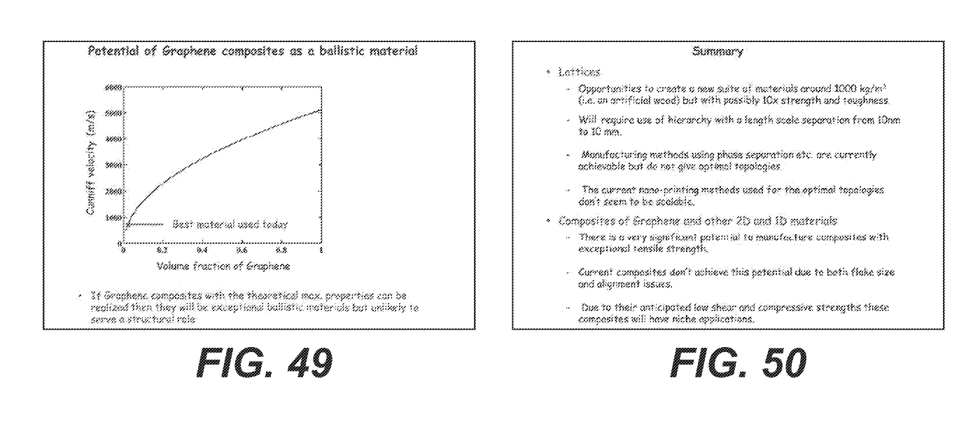

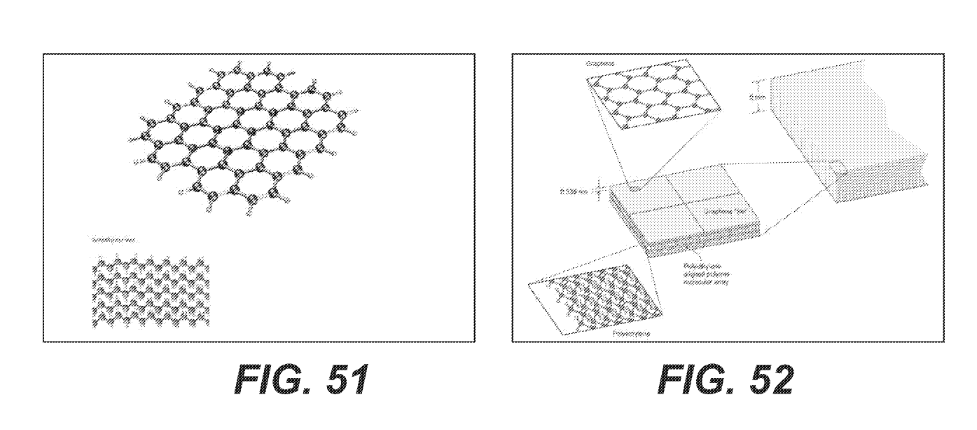

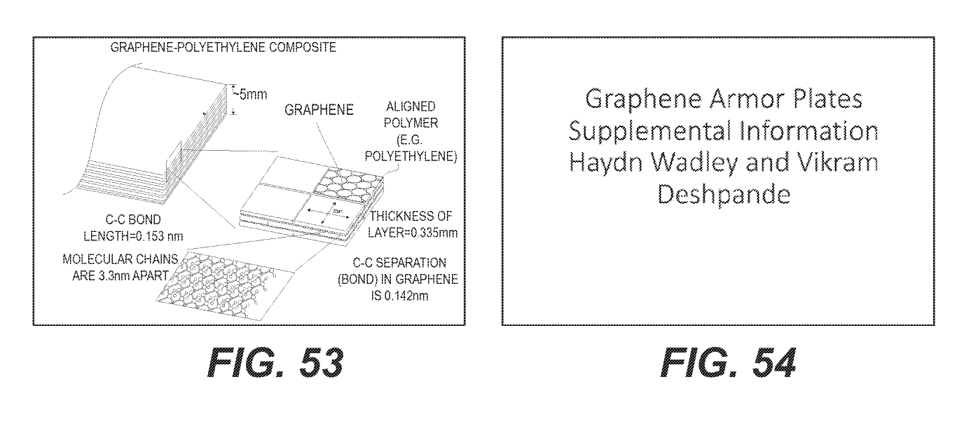

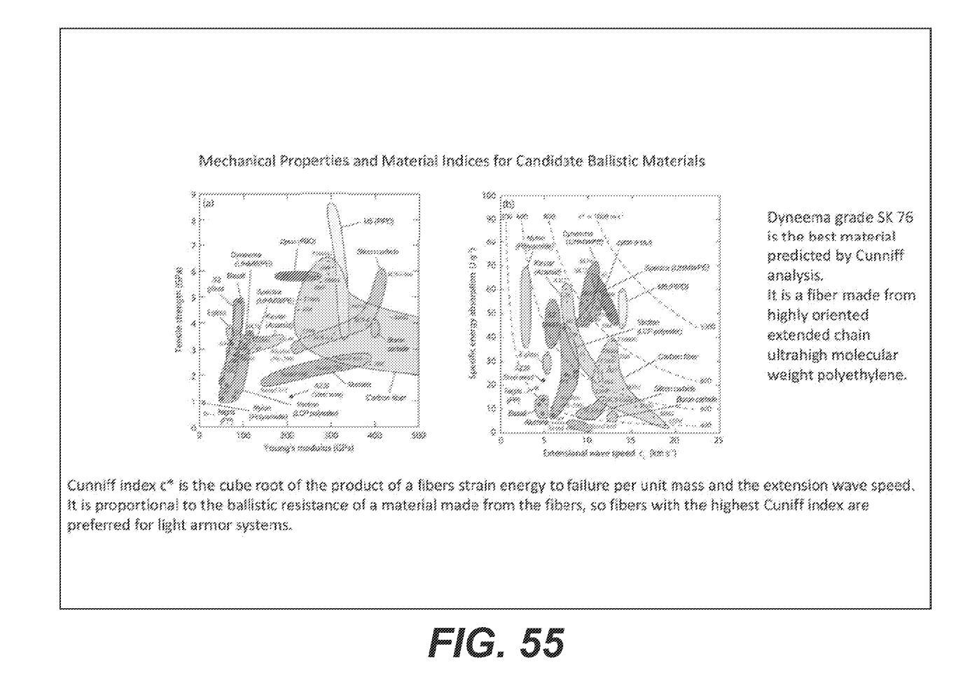

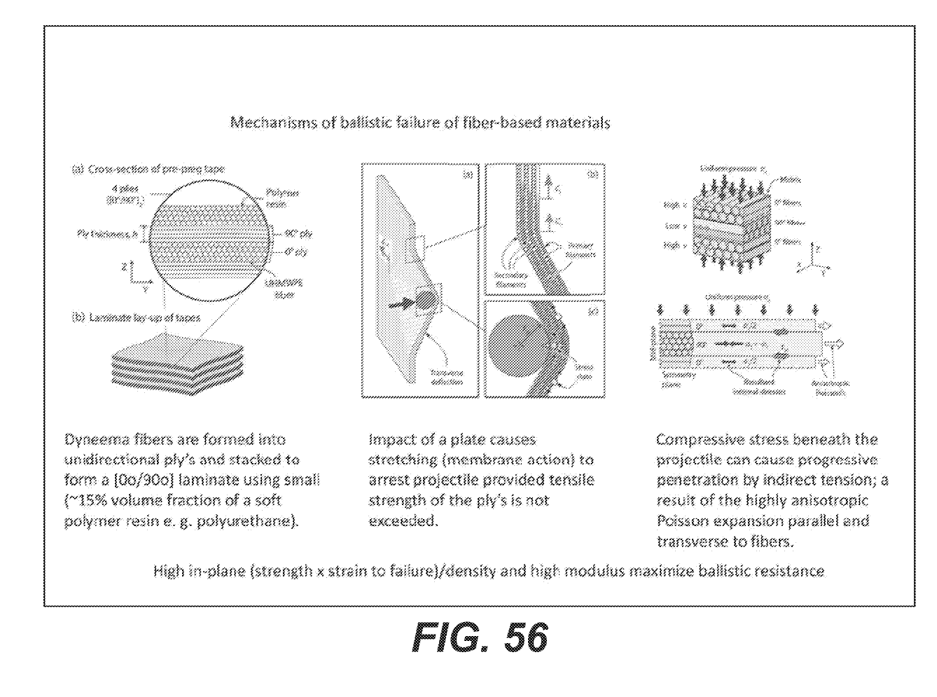

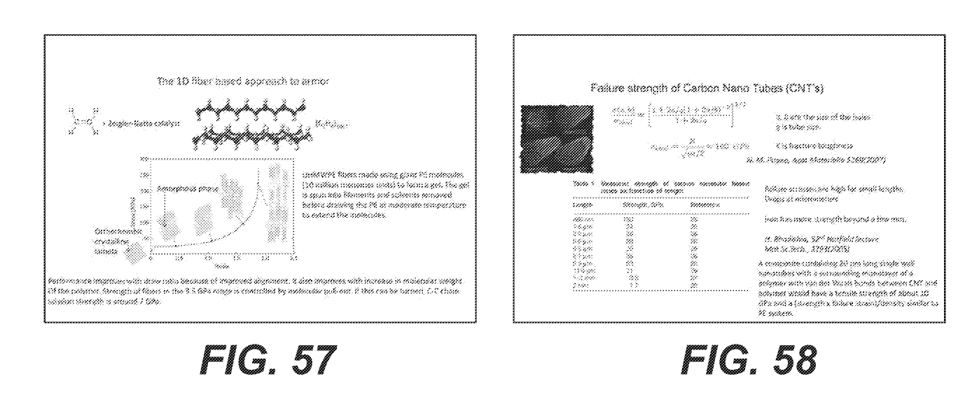

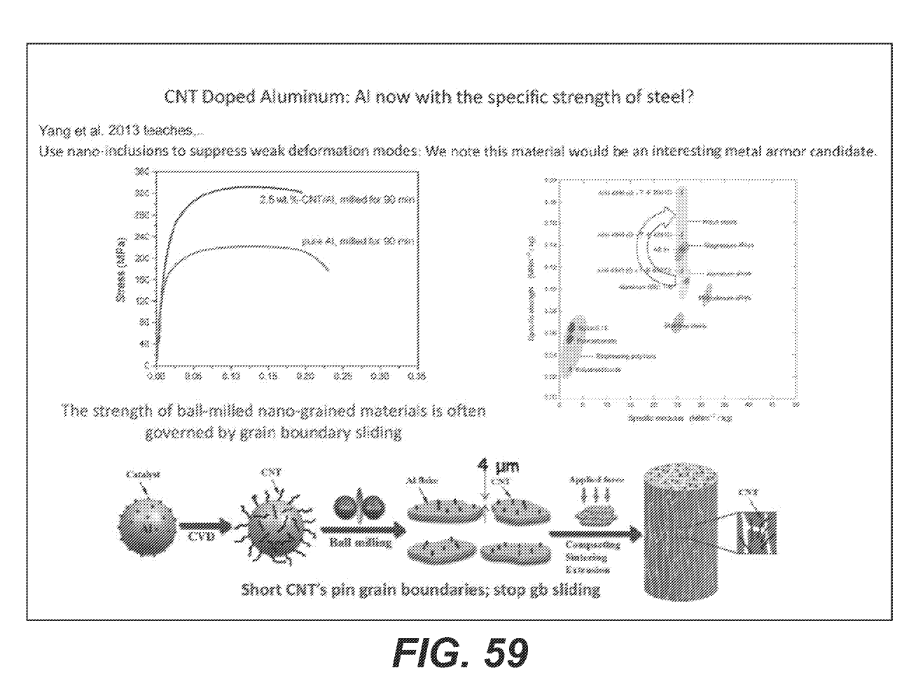

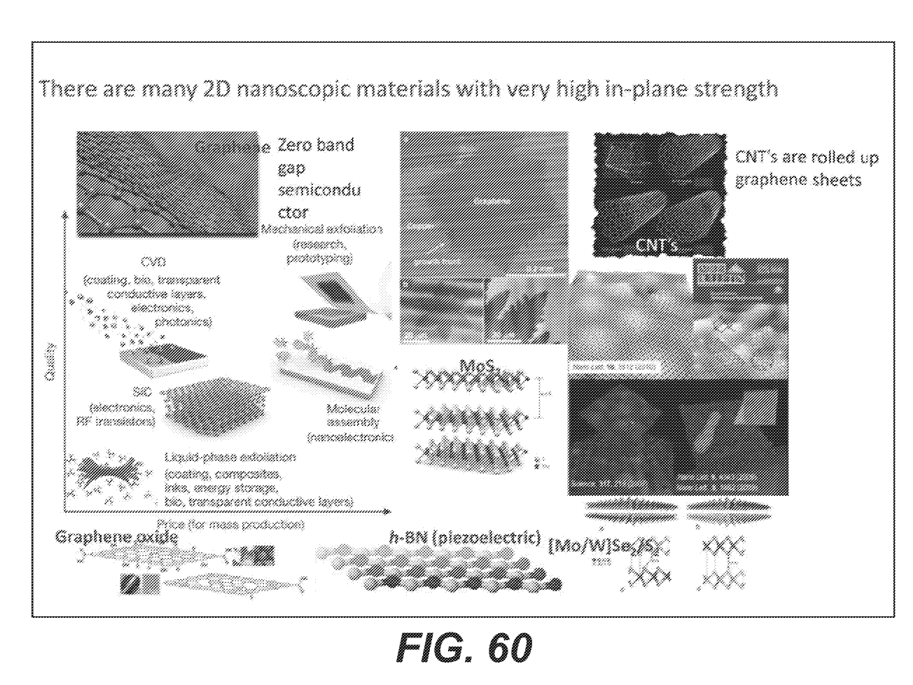

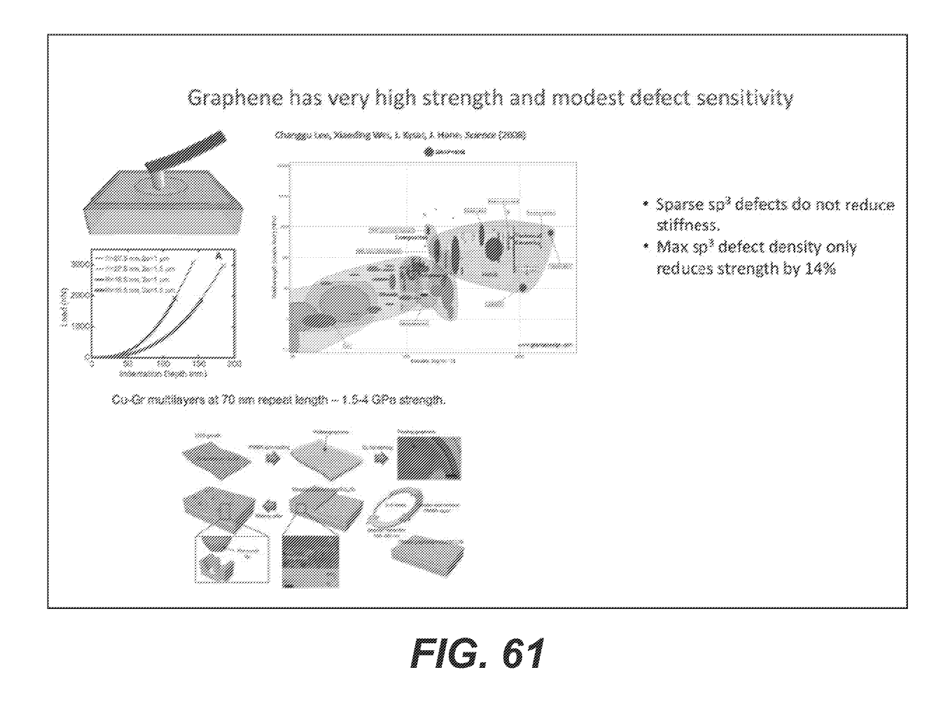

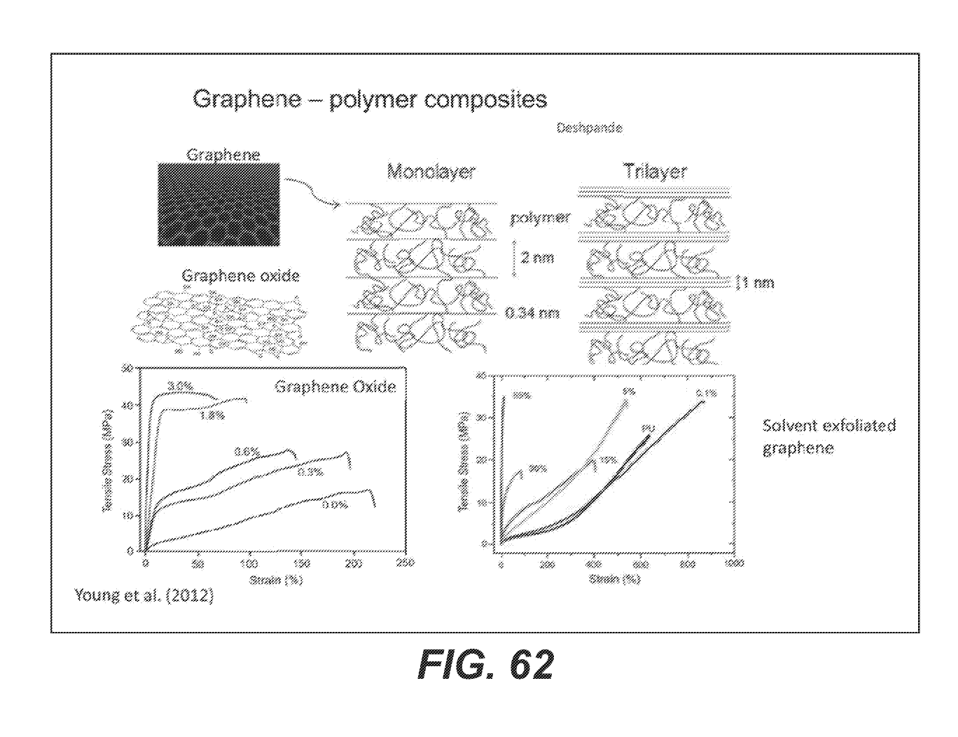

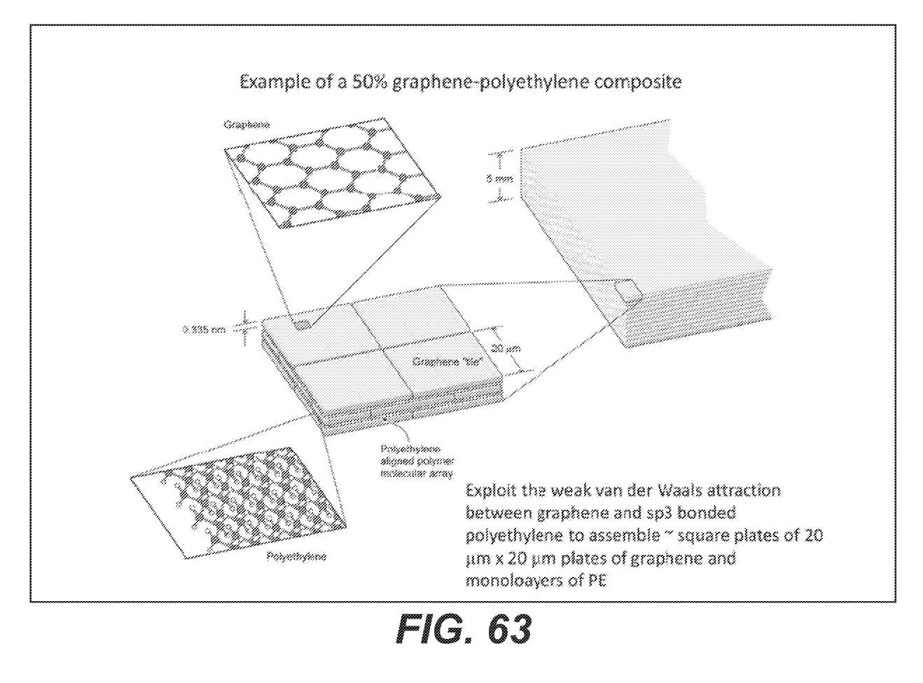

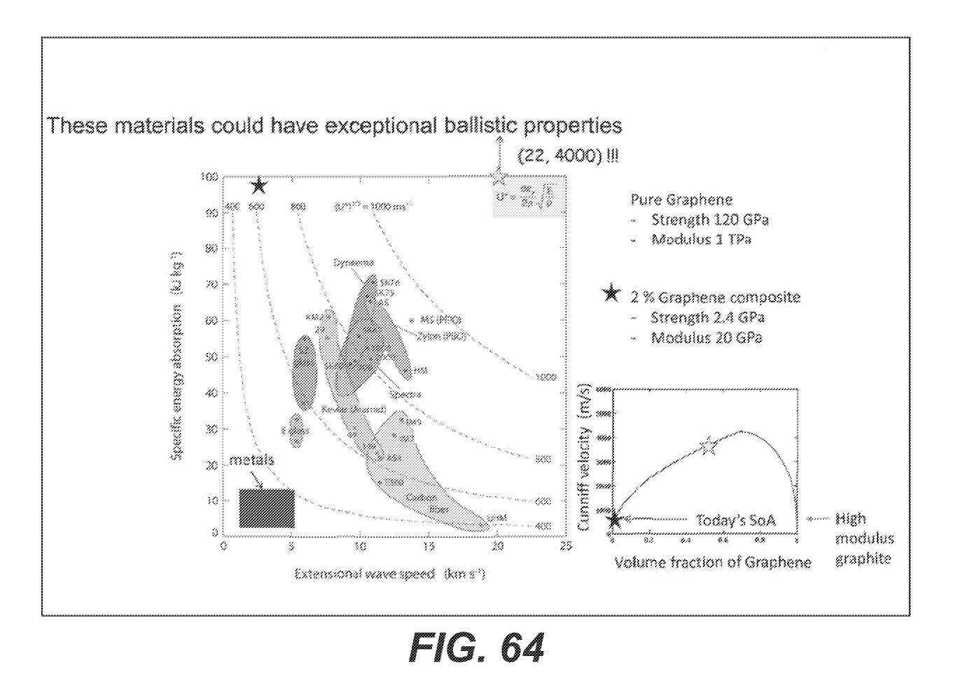

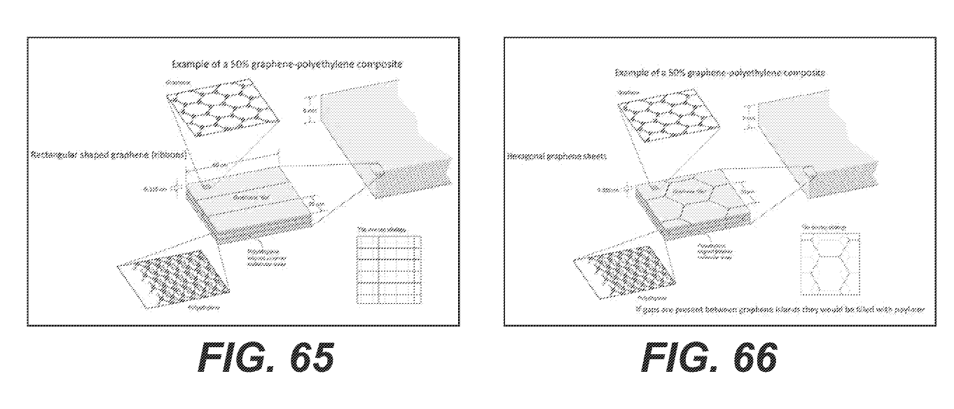

FIGS. 11 thru 67 provide the technical details and support for the invention, including maps of material properties or characteristics, testing of these materials, and use thereof.

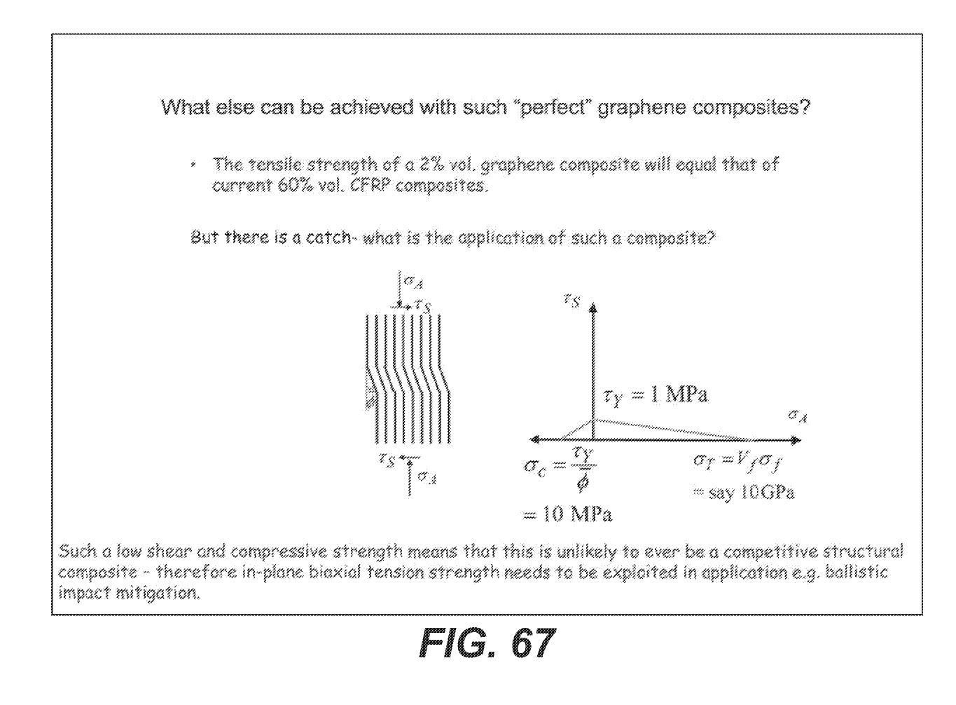

FIG. 67 shows the potential of graphene composites.

### Technical Support

The following patents, applications and publications as listed below and throughout this document provide technical support for the invention, and are hereby incorporated by reference in their entirety herein. It should be appreciated that various aspects of embodiments of the present method, system, devices, article of manufacture, and compositions may be implemented with the following methods, systems, devices, article of manufacture, and compositions disclosed in the following U.S. Patent Applications, U.S. Patents, Publications, and PCT International Patent Applications and are hereby incorporated by reference herein and co-owned with the assignee (and which are not admitted to be prior art with respect to the present invention by inclusion in this section):

International Patent Application Serial No. PCT/US2011/035581, entitled “Spotless Arc Directed Vapor Deposition (SA-DVD) and Related Method Thereof”, filed on May 6, 2011;

International Patent Application Serial No. PCT/US2011/031592, entitled “Multifunctional Armor Panel”, filed on Apr. 7, 2011, and corresponding U.S. application Ser. No. 13/640,239, filed on Oct. 9, 2012; U.S. Patent Application Publication No. US 2013/0263727, published Oct. 10, 2013;

International Patent Application Serial No. PCT/US2011/021121, entitled “Multifunctional Thermal Management System and Related Method”, filed Jan. 13, 2011, and corresponding U.S. patent application Ser. No. 13/522,264, entitled “Multifunctional Thermal Management System and Related Method”, filed Jul. 13, 2012; U.S. Patent Application Publication No. US 2013/0014916, published Jan. 17, 2013;

International Patent Application No. PCT/US2010/025259, entitled “Coaxial Hollow Cathode Plasma Assisted Directed Vapor Deposition and Related Method Thereof”, filed Feb. 24, 2010, and corresponding U.S. patent application Ser. No. 13/202,828, entitled “Coaxial Hollow Cathode Plasma Assisted Directed Vapor Deposition and Related Method Thereof”, filed Aug. 23, 2011; U.S. Patent Application Publication No. US 2011/0318498, published Dec. 29, 2011;

U.S. patent application Ser. No. 12/604,654, entitled “Interwoven Sandwich Panel Structures and Related Methods Thereof”, filed Oct. 23, 2009; U.S. Patent Application Publication No. US 2010/0104819, published Apr. 29, 2010. International Patent Application No. PCT/US2009/061888 entitled “Reactive Topologically Controlled Armors for Protection and Related Method”, filed Oct. 23, 2009;

U.S. patent application Ser. No. 12/479,408, entitled “Manufacture of Lattice Truss Structures from Monolithic Materials”, filed Jun. 5, 2009; U.S. Patent Application Publication Serial No. US 2009/028610, published Nov. 19, 2009;

U.S. patent application Ser. No. 12/408,250, entitled “Cellular Lattice Structures with Multiplicity of Cell Sizes and Related Method of Use”, filed Mar. 20, 2009;

International Application No. PCT/US2009/034690, entitled “Method for Manufacture of Cellular Structure and Resulting Cellular Structure”, filed Feb. 20, 2009;

International Application No. PCT/US2008/073377, entitled “Synergistically-Layered Armor Systems and Methods for Producing Layers Thereof”, filed Aug. 15, 2008, and corresponding U.S. patent application Ser. No. 12/673,647, entitled “Synergistically-Layered Armor Systems and Methods for Producing Layers Thereof”, filed Feb. 16, 2010;

International Patent Application No. PCT/US2008/073071, entitled “Thin Film Battery Synthesis by Directed Vapor Deposition”, filed Aug. 13, 2008, and corresponding U.S. patent application Ser. No. 12/733,160, entitled “Thin Film Battery Synthesis by Directed Vapor Deposition”, filed Feb. 16, 2010;

International Patent Application No. PCT/US2008/071848, entitled “Hybrid Periodic Cellular Material Structures, Systems, and Methods for Blast and Ballistic Protection,” filed Jul. 31, 2008, and corresponding U.S. patent application Ser. No. 12/673,418, entitled “Hybrid Periodic Cellular Material Structures, Systems, and Methods for Blast and Ballistic Protection,” filed Feb. 12, 2010; U.S. Patent Application Publication No. US 2011/0283873, published Nov. 24, 2011;

International Application No. PCT/US2008/060637, entitled “Heat-Managing Composite Structures,” filed Apr. 17, 2008, and corresponding U.S. patent application Ser. No. 12/596,548, entitled “Heat-Managing Composite Structures”, filed Oct. 19, 2009; U.S. Patent Application Publication No. US 2010/0236759, published Sep. 23, 2010;

International Application No. PCT/US2007/022733, entitled “Manufacture of Lattice Truss Structures from Monolithic Materials,” filed Oct. 26, 2007, and corresponding U.S. patent application Ser. No. 12/447,166, entitled “Manufacture of Lattice Truss Structures from Monolithic Materials,” filed Apr. 24, 2009; U.S. Pat. No. 8,176,635, issued May 15, 2012, and corresponding U.S. patent application Ser. No. 13/448,074, entitled “Manufacture of Lattice Truss Structures from Monolithic Materials,” filed Apr. 16, 2012;

International Application No. PCT/US2007/012268, entitled “Method and Apparatus for Jet Blast Deflection,” filed May 23, 2007, and corresponding U.S. patent application Ser. No. 12/301,916, entitled “Method and Apparatus for Jet Blast Deflection,” filed Oct. 7, 2009; U.S. Pat. No. 8,360,361, issued Jan. 29, 2013;

International Patent Application No. PCT/US2006/025978, entitled “Reliant Thermal Barrier Coating System and Related Methods and Apparatus of Making the Same,” filed Jun. 30, 2006, and corresponding U.S. patent application Ser. No. 11/917,585, entitled “Reliant Thermal Barrier Coating System and Related Methods and Apparatus of Making the Same,” filed Dec. 14, 2007; U.S. Pat. No. 8,084,086 issued Dec. 27, 2011, and corresponding U.S. patent application Ser. No. 13/337,133, entitled “Reliant Thermal Barrier Coating System and Related Methods and Apparatus of Making the Same,” filed Dec. 25, 2011; U.S. Patent Application Publication No. 2012/0160166, published Jun. 28, 2012;

International Patent Application No. PCT/US2005/000606, entitled “Apparatus and Method for Applying Coatings onto the Interior Surfaces of Components and Related Structures Produced There from,” filed Jan. 10, 2005, and corresponding U.S. patent application Ser. No. 10/584,682, entitled “Apparatus and Method for Applying Coatings onto the Interior Surfaces of Components and Related Structures Produced There from,” filed Jun. 28, 2006; U.S. Pat. No. 8,110,143, issued Feb. 7, 2012;

International Patent Application No. PCT/US2004/024232, entitled “Method for Application of a Thermal Barrier Coating and Resultant Structure Thereof,” filed Jul. 28, 2004, and corresponding U.S. patent application Ser. No. 10/566,316, entitled “Method for Application of a Thermal Barrier Coating and Resultant Structure Thereof,” filed Jan. 27, 2006;

International Application No. PCT/US04/04608, entitled “Methods for Manufacture of Multilayered Multifunctional Truss Structures and Related Structures There from,” filed Feb. 17, 2004, and corresponding U.S. patent application Ser. No. 10/545,042, entitled “Methods for Manufacture of Multilayered Multifunctional Truss Structures and Related Structures There from,” filed Aug. 11, 2005;

International Patent Application No. PCT/US2003/037485, entitled “Bond Coat for a Thermal Barrier Coating System and Related Method Thereof,” filed Nov. 21, 2003, corresponding to U.S. patent application Ser. No. 10/535,364, entitled “Bond Coat for a Thermal Barrier Coating System and Related Method Thereof,” filed May 18, 2005;

International Patent Application No. PCT/US2003/036035, entitled “Extremely Strain Tolerant Thermal Protection Coating and Related Method and Apparatus Thereof,” filed Nov. 12, 2003, and corresponding to U.S. patent application Ser. No. 10/533,993, entitled “Extremely Strain Tolerant Thermal Protection Coating and Related Method and Apparatus Thereof,” filed May 5, 2005;

International Application No. PCT/US03/27606, entitled “Method for Manufacture of Truss Core Sandwich Structures and Related Structures Thereof,” filed Sep. 3, 2003, and corresponding U.S. patent application Ser. No. 10/526,296, entitled “Method for Manufacture of Truss Core Sandwich Structures and Related Structures Thereof,” filed Mar. 1, 2005; U.S. Pat. No. 7,424,967, issued Sep. 16, 2008;

International Patent Application Serial No. PCT/US03/27605, entitled “Blast and Ballistic Protection Systems and Methods of Making Same,” filed Sep. 3, 2003, and corresponding U.S. patent application Ser. No. 10/526,414, entitled “Blast and Ballistic Protection Systems and Methods of Making Same,” filed Mar. 2, 2005; U.S. Pat. No. 7,913,611, issued Mar. 29, 2011;

International Patent Application No. PCT/US2003/023111, entitled “Method and Apparatus for Dispersion Strengthened Bond Coats for Thermal Barrier Coatings,” filed Jul. 24, 2003, and corresponding U.S. patent application Ser. No. 10/522,076, entitled “Method and Apparatus for Dispersion Strengthened Bond Coats for Thermal Barrier Coatings,” filed Jan. 21, 2005;

International Patent Application Serial No. PCT/US03/23043, entitled “Method for Manufacture of Cellular Materials and Structures for Blast and Impact Mitigation and Resulting Structure,” filed Jul. 23, 2003, and corresponding U.S. patent application Ser. No. 10/522,067, entitled “Method for Manufacture of Cellular Materials and Structures for Blast and Impact Mitigation and Resulting Structure,” filed Jan. 21, 2005;

International Patent Application No. PCT/US2003/017049, entitled “Active Energy Absorbing Cellular Metals and Method of Manufacturing and Using the Same,” filed May 30, 2003, and corresponding U.S. patent application Ser. No. 10/516,052 entitled “Active Energy Absorbing Cellular Metals and Method of Manufacturing and Using the Same,” filed Nov. 29, 2004; U.S. Pat. No. 7,288,326, issued Oct. 30, 2007, and corresponding U.S. patent application Ser. No. 11/857,856, entitled “Active Energy Absorbing Cellular Metals and Method of Manufacturing and Using the Same,” filed Sep. 19, 2007;

International Application No. PCT/US03/16844, entitled “Method for Manufacture of Periodic Cellular Structure and Resulting Periodic Cellular Structure,” filed May 29, 2003, and corresponding U.S. patent application Ser. No. 10/515,572, entitled “Method for Manufacture of Periodic Cellular Structure and Resulting Periodic Cellular Structure,” filed Nov. 23, 2004;

International Patent Application No. PCT/US2003/012920, entitled “Apparatus and Method for Uniform Line of Sight and Non-Line of Sight Coating at High Rate,” filed Apr. 25, 2003, and corresponding U.S. patent application Ser. No. 10/512,161, entitled “Apparatus and Method for Uniform Line of Sight and Non-Line of Sight Coating at High Rate,” filed Oct. 15, 2004; U.S. Pat. No. 7,718,222, issued May 18, 2010;

U.S. patent application Ser. No. 10/246,018, entitled “Apparatus and Method for Intra-layer Modulation of the Material Deposition and Assist Beam and the Multilayer Structure Produced There from,” filed Sep. 18, 2002, and corresponding U.S. patent application Ser. No. 09/634,457, entitled “Apparatus and Method for Intra-Layer Modulation of the Material Deposition and Assist Beam and the Multilayer Structure Produced There from,” filed Aug. 7, 2000; U.S. Pat. No. 6,478,931, issued Nov. 12, 2002;

International Patent Application No. PCT/US2002/28654, entitled “Method and Apparatus for Application of Metallic Alloy Coatings,” filed Sep. 10, 2002, and corresponding to U.S. patent application Ser. No. 10/489,090, entitled “Method and Apparatus Application of Metallic Alloy Coatings,” filed Mar. 9, 2004; U.S. Pat. No. 8,124,178, issued Feb. 28, 2012, and corresponding U.S. patent application Ser. No. 13/371,044, entitled “Method and Apparatus Application of Metallic Alloy Coatings,” filed Feb. 10, 2012; U.S. Patent Application Publication No. US 2012/0137974, published Jun. 7, 2012;

International Patent Application No. PCT/US2002/27116, entitled “Reversible Shape Memory Multifunctional Structural Designs and Method of Using and Making the Same,” filed Aug. 26, 2002, and corresponding U.S. patent application Ser. No. 10/487,291, entitled “Reversible Shape Memory Multifunctional Structural Designs and Method of Using and Making the Same,” filed Feb. 20, 2004; U.S. Pat. No. 7,669,799, issued Mar. 2, 2010;

International Application No. PCT/US02/17942, entitled “Multifunctional Periodic Cellular Solids and the Method of Making Thereof,” filed Jun. 6, 2002, and corresponding U.S. patent application Ser. No. 10/479,833, entitled “Multifunctional Periodic Cellular Solids and the Method of Making Thereof,” filed Dec. 5, 2003; U.S. Pat. No. 7,963,085, issued Jun. 21, 2011, and corresponding U.S. patent application Ser. No. 13/164,189, entitled “Multifunctional Periodic Cellular Solids and the Method of Making the Same,” filed Jun. 20, 2011;

International Patent Application No. PCT/US2002/13639, entitled “Method and Apparatus for Efficient Application of Substrate Coating,” filed Apr. 30, 2002, and corresponding U.S. patent application Ser. No. 10/476,309, entitled “Method and Apparatus for Efficient Application of Substrate Coating,” filed Oct. 29, 2003; U.S. Pat. No. 7,879,411, issued Feb. 1,2011;

International Application No. PCT/US01/25158, entitled “Multifunctional Battery and Method of Making the Same,” filed Aug. 10, 2001, and corresponding U.S. patent application Ser. No. 10/110,368, entitled “Multifunctional Battery and Method of Making the Same,” filed Apr. 9, 2002; U.S. Pat. No. 7,211,348, issued May 1, 2007, and corresponding U.S. patent application Ser. No. 11/788,958, entitled “Multifunctional Battery and Method of Making the Same,” filed Apr. 23, 2007; U.S. Patent Application Publication No. 2007/0269716, published Nov. 22, 2007;

International Application No. PCT/US01/22266, entitled “Method and Apparatus For Heat Exchange Using Hollow Foams and Interconnected Networks and Method of Making the Same,” filed Jul. 16, 2001, and corresponding U.S. patent application Ser. No. 10/333,004, entitled “Heat Exchange Foam,” filed Jan. 14, 2003; U.S. Pat. No. 7,401,643 issued Jul. 22, 2008, and corresponding U.S. patent application Ser. No. 11/928,161, “Method and Apparatus For Heat Exchange Using Hollow Foams and Interconnected Networks and Method of Making the Same,” filed Oct. 30, 2007. International Application No. PCT/US01/17363, entitled “Multifunctional Periodic Cellular Solids and the Method of Making Thereof,” filed May 29, 2001, and corresponding U.S. patent application Ser. No. 10/296,728, entitled “Multifunctional Periodic Cellular Solids and the Method of Making Thereof,” filed Nov. 25, 2002; U.S. Pat. No. 8,247,333, issued Aug. 21, 2012;

International Patent Application No. PCT/US2001/16693, entitled “A Process and Apparatus for Plasma Activated Deposition in Vacuum,” filed May 23, 2001, and corresponding U.S. patent application Ser. No. 10/297,347, entitled “Process and Apparatus for Plasma Activated Deposition in a Vacuum,” filed Nov. 21, 2002; U.S. Pat. No. 7,014,889, issued Mar. 21, 2006;

International Patent Application No. PCT/US1999/13450, entitled “Apparatus and Method for Producing Thermal Barrier Coatings,” filed Jun. 15, 1999;

International Patent Application No. PCT/US1997/11185, entitled “Production Of Nanometer Particles By Directed Vapor Deposition of Electron Beam Evaporant,” filed Jul. 8, 1997;

U.S. patent application Ser. No. 08/679,435, entitled “Production of Nanometer Particles by Directed Vapor Deposition of Electron Beam Evaporant,” filed Jul. 8, 1996; U.S. Pat. No. 5,736,073, issued Apr. 7, 1998; and

U.S. patent application Ser. No. 08/298,614, entitled “Directed Vapor Deposition of Electron Beam Evaporant,” filed Aug. 31, 1994; U.S. Pat. No. 5,534,314, issued Jul. 9, 1996.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following disclosure, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

1. A method of making a graphene composite comprising:
making graphene flakes or tiles:
making a graphene layer from the graphene flakes or tiles; and
applying a polymer layer to the graphene layer.

2. The method according to claim 1, wherein the polymer is a polyethylene layer.

3. The method according to claim 1, wherein the graphene flakes or tiles are hexagon shaped.

4. The method according to claim 1, wherein the graphene composite comprises multiple graphene layers.

5. The method according to claim 1, wherein the graphene composite comprises alternating graphene layers and polyethylene layers.

6. The method according to claim 1, wherein consecutive graphene layers are arranged so that the graphene flakes or tiles of one graphene layer overlaps joints of graphene flakes or tiles of a next consecutive layer.

7. The method according to claim 6, wherein the graphene flakes or tiles of the one graphene layer are centered over the joints of the graphene flakes or tiles of the next consecutive layer.

8. The method according to claim 3, wherein the graphene flakes or tiles have a width of 20 μm and a thickness of 0.335 nm.

9. The method according to claim 1, wherein the graphene flakes or tiles are made by passing a input graphite slurry under pressure through a micro-fluidic labyrinth; separating the graphene flakes or tiles; making a graphene ink; printing or spraying one or more graphene layers; making nano-scale thick composite plies; and roll bonding the nano-scale thick composite plies to produce a micro-scale composite.

10. A graphene composite comprising:
a graphene layer comprising graphene flakes or tiles; and
a polymer layer connected to the graphene layer.

11. The graphene composite according to claim 10, wherein the polymer layer is a polyethylene layer.

12. The graphene composite according to claim 10, wherein the graphene flakes or tiles have a width of 20 μm and a thickness of 0.335 nm.

13. The graphene composite according to claim 10, wherein the graphene composite is made with alternating layers of the graphene layer and the polymer layer.

14. The graphene composite according to claim 13, wherein the graphene flakes or tiles of one graphene layer overlap with the joints between graphene flakes or tiles of a next consecutive graphene layer.

15. The graphene composite according to claim 14, wherein the graphene flakes or tiles of the one graphene layer are centered over the joints of the graphene flakes or tiles of the next consecutive graphene layer.
